(19) United States
(12) Patent Application Publication
(10) Pub. No.: US 2024/0316533 A1
(43) Pub. Date: Sep. 26, 2024

(54) METHOD OF DRAINING WATER

(71) Applicant: ROCKWOOL A/S, Hedehusene (DK)

(72) Inventors: Daan DE KUBBER, Hedehusene (DK); Michaeel EMBORG, Hedehusene (DK); Dorte BARTNIK JOHANSSON, Hedehusene (DK); Miroslav NIKOLIC, Hedehusene (DK)

(21) Appl. No.: 18/259,352

(22) PCT Filed: Oct. 1, 2021
(86) PCT No.: PCT/EP2021/077191

§ 371 Date: Jun. 26, 2023

(30) Foreign Application Priority Data
Dec. 30, 2020 (WO) PCT/EP2020/088061

(51) Int. Cl. B01J 20/28; B01J 20/24; B01J 20/30

(52) U.S. Cl. CPC B01J 20/28023; B01J 20/24; B01J 20/28004; B01J 20/2803; B01J 20/3042; B01J 2220/4837

(57) ABSTRACT

The present invention relates to a method of draining water comprising the steps of:
providing a water drainage device, wherein the water drainage device comprises man-made vitreous fibres (MMVF) bonded with a cured aqueous binder composition free of phenol and formaldehyde;
positioning the water drainage device in contact with the ground, wherein the water drainage device absorbs water and releases water to a recipient

wherein the aqueous binder composition prior to curing comprises;
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

### FIELD OF THE INVENTION

The present invention relates to a method of draining water, a water drainage device and an array of two or more water drainage devices.

### BACKGROUND OF THE INVENTION

Precipitation, such as rain, snow, sleet, hail and the like, results in excess water which must be safely collected and/or transported elsewhere. Typically, guttering and main drainage systems are used to collect excess water and transport it to a water collection point. However, often surface water remains on the ground which can cause the ground to become waterlogged or flooded.

It is known to have devices comprising man-made vitreous fibres that can absorb and store excess surface water, and gradually dissipate it back into the surrounding ground. It is also known to have devices that absorb excess surface water and transport the water elsewhere.

WO 2013/113410 discloses a drain element formed of a hydrophilic coherent man-made vitreous fibre substrate, wherein the MMVF substrate comprises man-made vitreous fibres bonded with a cured binder composition, the MMVF substrate having opposed first and second ends and a passage which extends from a first opening in the first end to a second opening in the second end.

WO 2013/072082 discloses a water drain reservoir comprising a coherent man-made vitreous fibre substrate and a conduit having two open ends wherein the MMVF substrate comprises man-made vitreous fibres bonded with a cured binder composition, wherein a first open end of the conduit is in fluid communication with the MMVF substrate.

WO 2014/029873 discloses a structure for draining surface water, comprising a coherent force distribution layer and a drain layer, wherein the drain layer is formed of an array of coherent man-made vitreous fiber (MMVF) drain elements, wherein each of the drain elements comprises man-made vitreous fibres bonded with a cured binder composition, wherein the drain layer is below the force distribution layer.

WO 2014/029872 discloses a device comprising a coherent manmade vitreous fibre substrate and at least one first conduit and at least one second conduit, each conduit having first and second open ends, wherein the MMVF substrate comprises man-made vitreous fibres bonded with a cured binder composition, wherein the first open end of the first conduit and the first open end of the second conduit are each independently in fluid communication with the MMVF substrate, wherein the first conduit is at a greater height than the second conduit, wherein at least a portion of the MMVF substrate is disposed between the first and second conduits.

Such devices typically comprise phenol-formaldehyde resins and phenol-formaldehyde urea resins as binders. These binders are economical to produce and provide excellent mechanical handling properties. This is highly important as the devices are positioned underground and must be able to withstand the process of installation, and then pressure from above the ground during use (e.g. from vehicles).

However, existing and proposed legislation directed to the lowering or elimination of formaldehyde emissions from the production facility, but also in the working environment, has led to the development of formaldehyde-free binders. There is also an on-going trend for consumers to prefer products that are fully or at least partially produced from renewable materials and there is therefore a need to provide binders for water absorbing devices which are at least partially produced from renewable materials. Furthermore, known formaldehyde-based binders often involved corrosive and/or harmful components. This required protective measures for the machinery and safety measures for persons handling the machinery.

Formaldehyde-free binders for water-absorbing devices have been proposed before. However, there are still some disadvantages associated with MMVF products prepared with these binders in terms of lower mechanical properties, when compared with MMVF products prepared with phenol-formaldehyde resins. In addition, such binders are often made from expensive starting materials.

In addition, there is an ongoing desire to improve the water holding properties of drainage devices, for example; water absorption.

Furthermore, known MMVF drainage devices typically contain wetting agents to improve hydrophilicity. However, certain wetting agents may be washed out of the MMVF product over time. This is particularly problematic as drainage devices are positioned in the ground and thus the wetting agent may leach out and contaminate the surrounding ground. In addition, as the wetting agent is washed out, the drainage properties of the device significantly change. Finally, there is an ongoing desire to reduce the number of components required to produce MMVF drainage devices for both environmental and cost efficiency purposes.

Therefore, it would be desirable to produce a MMVF water drainage device comprising a binder that is formaldehyde-free but has equivalent or superior mechanical handling properties (e.g. wet strength and delamination strength) as phenol-formaldehyde binders. It would be desirable for such a device to have improved water holding properties (e.g. water absorption). Furthermore, it would be desirable for such a binder to be economical to produce and be based predominantly on renewable sources. Finally, it would be desirable for such a binder not to require the further addition of wetting agent and thus prevent leaching of wetting agents into the surrounding ground.

### SUMMARY OF THE INVENTION

The water drainage device used in the present invention solves the above problems.

In a first aspect, there is provided a method of draining water comprising the steps of:
providing a water drainage device, wherein the water drainage device comprises man-made vitreous fibres (MMVF) bonded with a cured aqueous binder composition free of phenol and formaldehyde;
positioning the water drainage device in contact with the ground, wherein the water drainage device absorbs water and releases water to a recipient;

wherein the aqueous binder composition prior to curing comprises;
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

In a second aspect of the invention there is provided a water drainage device comprising man-made vitreous fibres (MMVF) bonded with a cured aqueous binder composition free of phenol and formaldehyde, wherein the aqueous binder composition prior to curing comprises;
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

In a third aspect of the invention there is provided an array of two or more water drainage devices, wherein the water drainage devices comprise man-made vitreous fibres (MMVF) bonded with a cured aqueous binder composition free of phenol and formaldehyde, wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

In a fourth aspect of the invention, there is provided a method of producing a water drainage device comprising the steps of:
(i) providing man-made vitreous fibres;
(ii) spraying the man-made vitreous fibres with an aqueous binder composition free of phenol and formaldehyde;
(iii) collecting and consolidating the man-made vitreous fibres and curing the aqueous binder composition to form a water drainage device;

wherein the binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

In a fifth aspect of the invention, there is provided use of a lignin component in form of one or more lignosulfonate lignins having a carboxylic acid group content of 0.03 to 1.4 mmol/g, based on the dry weight of the lignosulfonate lignins, for the preparation of a binder composition free of phenol and formaldehyde for a water drainage device comprising man-made vitreous fibres (MMVF).

The present inventors discovered that it is possible to produce a formaldehyde-free binder which leads to a device with equivalent mechanical handling properties (e.g. wet strength and delamination strength) to devices bonded with phenol-formaldehyde binders. The inventors also produced such a binder that leads to devices that have improved water holding properties (e.g. water absorption), which is highly beneficial for water drainage. The inventors produced such a binder that is economical and is based predominantly on renewable sources. Finally, this binder means that the addition of a wetting agent to the device is not required, preventing leaching of wetting agent into the surrounding ground and providing both environmental and cost advantages.

### DESCRIPTION OF THE FIGURES

FIG. 1 shows commonly used model structure of lignosulfonates.

FIG. 2 shows schematically a water drainage device completely buried in the ground and connected to the guttering of a house.

FIG. 3 shows a water drainage device comprising a passage.

FIG. 4 shows the results of delamination strength % after aging.

### DETAILED DESCRIPTION

The invention relates to a method of draining water comprising the steps of:
providing a water drainage device, wherein the water drainage device comprises man-made vitreous fibres (MMVF) bonded with a cured aqueous binder composition free of phenol and formaldehyde;
positioning the water drainage device in contact with the ground, wherein the water drainage device absorbs water and releases water to a recipient;

wherein the aqueous binder composition prior to curing comprises;
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

The invention relates to draining water, preferably draining surface water. It may be directed to draining surface water from recreation grounds such as children's playgrounds and sports grounds. Sports grounds include football pitches, rugby pitches, cricket pitches, lawn bowling greens, lawn tennis courts, golf greens, playing fields, athletic grounds and equestrian centres. It may also be directed to draining water from gardens, parks or fields. It may also be directed to draining water from guttering and draining systems of buildings or streets.

A water drainage device has its normal meaning in the art. It is a device which is capable of draining water. Drainage means the removal of surface water or sub-surface water from an area with excess water. It can do this by absorbing water and retaining it in its structure, or transferring the water to a recipient, for example, to a water collection point. The water drainage device of the invention may also be called a water delay device, or a water storage device or a water buffering device. This is because it delays the arrival of water at collection points, by absorbing it and holding it within its structure.

A water drainage device is hydrophilic, that is, it attracts water. Hydrophilic has its normal meaning in the art.

The hydrophilicity of the water drainage device may be defined in terms of the contact angle with water. Preferably, the MMVF of the device has a contact angle with water of less than 90°. The contact angle is measured by a sessile drop measurement method. Any sessile drop method can be used, for example with a contact angle goniometer. In practice, a droplet is placed on the solid surface and an image of the drop is recorded in time. The static contact angle is then defined by fitting Young-Laplace equation around the droplet. The contact angle is given by the angle between the calculated drop shape function and the sample surface, the projection of which in the drop image is referred to as the baseline. The equilibrium contact angles are used for further evaluation and calculation of the surface free energy using the Owens, Wendt, Rabel and Kaeble method. The method for calculating the contact angle between material and water is well-known to the skilled person.

Hydrophilicity of the drainage device may be defined by the hydraulic conductivity. Preferably, the drainage device has a hydraulic conductivity of 5 m/day to 300 m/day, preferably 50 m/day to 200 m/day. Hydraulic conductivity is measured in accordance with ISO 17312:2005. The advantage of this hydraulic conductivity is that the drainage device can absorb excess water and transfer it away with sufficient speed to prevent flooding.

The hydrophilicity of a sample of MMVF substrate can also be measured by determining the sinking time of a sample. A sample of MMVF substrate having dimensions of 100×100×100 mm is required for determining the sinking time. A container with a minimum size of 200×200×200 mm is filled with water. The sinking time is the time from when the sample first contacts the water surface to the time when the test specimen is completely submerged. The sample is placed in contact with the water in such a way that a cross-section of 100×100 mm first touches the water. The sample will then need to sink a distance of just over 100 mm in order to be completely submerged. The faster the sample sinks, the more hydrophilic the sample is. The MMVF substrate is considered hydrophilic if the sinking time is less than 120 s. Preferably the sinking time is less than 60 s. In practice, the water drainage device may have a sinking time of a few seconds, such as less than 15 seconds, preferably less than 10 seconds.

The method of the present invention comprises a water drainage device comprising man-made vitreous fibres (MMVF). The man-made vitreous fibres (MMVF) can have any suitable oxide composition. The fibres can be glass fibres, ceramic fibres, basalt fibres, slag fibres or rock or stone fibres. The fibres are preferably of the types generally known as rock, stone or slag fibres, most preferably stone fibres.

Stone fibres commonly comprise the following oxides, in percent by weight:
SiO₂: 30 to 51
Al₂O₃: 12 to 30
CaO: 8 to 30
MgO: 2 to 25
FeO (including Fe₂O₃): 2 to 15
Na₂O+K₂O: not more than 10
CaO+MgO: 10 to 30

In preferred embodiments the MMVF have the following levels of elements, calculated as oxides in wt %:
SiO₂: at least 30, 32, 35 or 37; not more than 51, 48, 45 or 43
Al₂O₃: at least 12, 16 or 17; not more than 30, 27 or 25
CaO: at least 8 or 10; not more than 30, 25 or 20
MgO: at least 2 or 5; not more than 25, 20 or 15
FeO (including Fe₂O₃): at least 4 or 5; not more than 15, 12 or 10
FeO+MgO: at least 10, 12 or 15; not more than 30, 25 or 20
Na₂O+K₂O: zero or at least 1; not more than 10
CaO+MgO: at least 10 or 15; not more than 30 or 25
TiO2: zero or at least 1; not more than 6, 4 or 2
TiO₂+FeO: at least 4 or 6; not more than 18 or 12
B₂O₃: zero or at least 1; not more than 5 or 3
P₂O₅: zero or at least 1; not more than 8 or 5
Others: zero or at least 1; not more than 8 or 5

The MMVF made by the method of the invention preferably have the composition in wt %:
SiO₂ 35 to 50
Al₂O₃ 12 to 30
TiO₂ up to 2
Fe₂O₃ 3 to 12
CaO 5 to 30
MgO up to 15
Na₂O 0 to 15
K₂O 0 to 15
P₂O₅ up to 3
MnO up to 3
B₂O₃ up to 3

Another preferred composition for the MMVF is as follows in wt %:
SiO₂ 39-55% preferably 39-52%
Al₂O₃ 16-27% preferably 16-26%
CaO 6-20% preferably 8-18%
MgO 1-5% preferably 1-4.9%
Na₂O 0-15% preferably 2-12%
K₂O 0-15% preferably 2-12%
R₂O (Na₂O+K₂O) 10-14.7% preferably 10-13.5%
P₂O₅ 0-3% preferably 0-2%
Fe₂O₃ (iron total) 3-15% preferably 3.2-8%
B₂O₃ 0-2% preferably 0-1%
TiO₂ 0-2% preferably 0.4-1%
Others 0-2.0%

Glass fibres commonly comprise the following oxides, in percent by weight:
SiO₂: 50 to 70
Al₂O₃: 10 to 30
CaO: not more than 27
MgO: not more than 12

Glass fibres can also contain the following oxides, in percent by weight:
Na₂O+K₂O: 8 to 18, in particular Na₂O+K₂O greater than CaO+MgO
B₂O₃: 3 to 12

Some glass fibre compositions can contain Al₂O₃ less than 2%.

The geometric mean fibre diameter is often in the range of 1.5 to 10 microns, in particular 2 to 8 microns, preferably 2 to 5 microns. The inventors found that this range of geometric fibre diameter positively affects capillarity thus improving water uptake in the device.

Preferably the water drainage device comprises at least 90 wt % man-made vitreous fibres by weight of the total solid content of the water drainage device. An advantage of having such an amount of fibres present in the water drainage device is that there are sufficient pores formed between the fibres to allow the device to hold large amounts of water. The remaining solid content may be made up primarily of binder.

The water drainage device is preferably in the form of a coherent MMVF substrate i.e. a coherent mass. That is, the water drainage device is preferably a coherent matrix of man-made vitreous fibres, which has been produced as such, but can also be formed by granulating a slab of mineral wool and consolidating the granulated material. A coherent substrate is a single, unified substrate.

The water drainage device according to the invention may optionally comprise a wetting agent. A wetting agent has its normal meaning in the art, and may be a cationic, anionic or non-ionic surfactant.

The water drainage device may comprise a non-ionic wetting agent such as Rewopal®.

The water drainage device may comprise an ionic surfactant, more preferably an alkyl ether sulphate surfactant wetting agent. The wetting agent may be an alkali metal alkyl ether sulphate or an ammonium alkyl ether sulphate. Preferably the wetting agent is a sodium alkyl ether sulphate. A commercially available alkyl ether sulphate surfactant wetting agent is Texapon®. The wetting agent may also be a linear alkyl benzene sulphonate anionic surfactant.

Some non-ionic wetting agents may be washed out of the MMVF water drainage device over time. It is therefore preferable to use an ionic wetting agent, especially an anionic wetting agent, such as linear alkyl benzene sulphonate or Texapon®. These do not wash out of the MMVF device to the same extent.

The water drainage device may comprise 0.01 to 1 wt % wetting agent, preferably 0.05 to 0.5 wt % wetting agent, more preferably 0.1 to 0.3 wt % wetting agent.

However, the inventors discovered that a wetting agent is not essential for the water drainage device according to the invention. This is believed to be due to the nature of the binder composition. Therefore, preferably the water drainage device does not comprise any wetting agent. By this, it is meant that the water drainage device preferably comprises no wetting agent i.e. comprises 0 wt % wetting agent.

This has several advantages. Firstly, it reduces the number of additives in the device which is environmentally advantageous, and also saves costs. Often wetting agents are made from non-renewable sources so it is beneficial to avoid their use. Additionally, wetting agents may be washed out of the water drainage device. This is problematic because the wetting agent may contaminate the surrounding ground. When a wetting agent is washed out this also changes the nature of the water drainage device, typically changing buffering, drainage and infiltration, making it difficult to predict the behaviour. Avoiding the use of a wetting agent avoids these problems.

The water drainage comprising MMVF preferably has a density in the range of 60 to 200 kg/m³, in particular in the range 120 to 160 kg/m³. The advantage of this density is that the water drainage device has relatively high compression strength. This is important as the water drainage device may be installed in a position where people or vehicles need to travel over the ground in which the device is positioned. Optionally a force distribution plate is positioned on top of the water drainage device in order to distribute the force applied to the water drainage device. Preferably such a force distribution plate is not required due to the density of the water drainage device.

The water drainage device comprising MMVF preferably has volume in the range of 10 litres to 300 litres, preferably 100 litres to 250 litres, more preferably 150 litres to 200 litres. The precise volume is chosen according to the volume of water which is expected to be managed. Furthermore, multiple devices can be used in an area.

The water drainage device generally have a loss on ignition (LOI) within the range of 0.3 to 18.0%, preferably 0.5 to 8.0%.

Preferably, the water drainage device comprises 1.0 wt % to 6.0 wt % of cured binder composition, preferably 2.0 wt % to 4.5 wt %, most preferably 2.5 wt % to 3.5 wt % based on the weight of the water drainage device. Determination of binder content is performed according to DS/EN13820:2003. The binder content is taken as the loss on ignition. The binder content includes any binder additives.

The water drainage device according to the invention comprises, prior to curing, an aqueous binder composition free of phenol and formaldehyde comprising:
a component (i) in form of one or more lignosulfonate lignins having a carboxylic acid group content of 0.03 to 1.4 mmol/g, based on the dry weight of the lignosulfonate lignins, and
a component (ii) in form of one or more cross-linkers.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers,

with the proviso that the aqueous binder composition does not comprise a cross-linker selected from epoxy compounds having a molecular weight Mw of 500 or less.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers,

with the proviso that the aqueous binder composition does not comprise a cross-linker selected from:
carbonyl compounds selected from aldehydes, carbonyl compounds of the formula R—[C(O)R₁]ₓ

in which:

R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups, R₁ represents a hydrogen atom or a C₁-C₁₀ alkyl radical, and x varies from 1 to 10.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers,

with the proviso that the aqueous binder composition does not comprise a cross-linker selected from polyamines.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers,

with the proviso that the aqueous binder composition does not comprise a cross-linker selected from mono- and oligosaccharides.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers selected from:
   β-hydroxyalkylamide-cross-linkers, such as N-(2-hydroxyisopropyl)amide-cross-linkers, such as N-(2-hydroxyethyl)amide-cross-linkers, such as N-(2-hydroxyethyl)adipamide-cross-linkers, such as N,N,N′,N′-tetrakis(2-hydroxyethyl)adipamide and/or
   the group consisting of multifunctional organic amines such as an alkanolamine, diamines, such as hexamethyldiamine, and/or
   epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, and/or
   one or more cross-linkers in form of multifunctional carbodiimides, such as aliphatic multifunctional carbodiimides, and/or
   Primid XL-552,

with the proviso that the aqueous binder composition does not comprise a cross-linker selected from:
epoxy compounds having a molecular weight Mw of 500 or less
carbonyl compounds selected from aldehydes, carbonyl compounds of the formula R—[C(O)R₁]ₓ

in which:

R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups, R₁ represents a hydrogen atom or a C₁-C₁₀ alkyl radical, and x varies from 1 to 10,
polyamines.

Optionally, the aqueous binder composition additionally comprises
a component (iii) in form of one or more plasticizers.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers;
a component (iii) in form of one or more plasticizers.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers;
a component (iii) in form of one or more plasticizers,

with the proviso that the aqueous binder composition does not comprise a cross-linker selected from epoxy compounds having a molecular weight Mw of 500 or less.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers;
a component (iii) in form of one or more plasticizers,

with the proviso that the aqueous binder composition does not comprise a cross-linker selected from:
carbonyl compounds selected from aldehydes, carbonyl compounds of the formula R—[C(O)R₁]ₓ

in which:

R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups, R₁ represents a hydrogen atom or a C₁-C₁₀ alkyl radical, and x varies from 1 to 10.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers;
a component (iii) in form of one or more plasticizers,

with the proviso that the aqueous binder composition does not comprise a cross-linker selected from polyamines.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers;
a component (iii) in form of one or more plasticizers,

with the proviso that the aqueous binder composition does not comprise a cross-linker selected from mono- and oligosaccharides.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers selected from
   β-hydroxyalkylamide-cross-linkers, and/or
   epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, and/or
   one or more cross-linkers in form of multifunctional carbodiimides, such as aliphatic multifunctional carbodiimides; and/or
   Primid XL-552;
a component (iii) in form of one or more plasticizers,

with the proviso that the aqueous binder composition does not comprise a cross-linker selected from
epoxy compounds having a molecular weight Mw of 500 or less
carbonyl compounds selected from aldehydes, carbonyl compounds of the formula R—[C(O)R₁]ₓ

in which:

R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups, R₁ represents a hydrogen atom or a C₁-C₁₀ alkyl radical, and x varies from 1 to 10,
polyamines.

In a preferred embodiment, the binders are formaldehyde free.

For the purpose of the present application, the term “formaldehyde free” is defined to characterize a MMVF product where the emission is below 5 μg/m²/h of formaldehyde from the MMVF product, preferably below 3 μg/m²/h. Preferably, the test is carried out in accordance with ISO 16000 for testing aldehyde emissions.

In a preferred embodiment, the binders are phenol free.

For the purpose of the present application, the term “phenol free” is defined in such a way that the aqueous binder composition does contain phenol

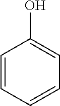

in an amount of ≤0.25 wt.-%, such as ≤0.1 wt.-%, such as ≤0.05 wt.-%, based on the total weight of an aqueous composition having a dry solids binder content of 15 wt. %.

In one embodiment, the binder composition does not contain added formaldehyde.

In one embodiment, the binder composition does not contain added phenol.

For the purpose of the present invention, the term “mono- and oligosaccharides” is defined to comprise monosaccharides and oligosaccharides having 10 or less saccharide units.

For the purpose of the present invention, the term “sugar” is defined to comprise monosaccharides and oligosaccharides having 10 or less saccharide units.

### Component (i)

Component (i) is in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins.

Lignin, cellulose and hemicellulose are the three main organic compounds in a plant cell wall. Lignin can be thought of as the glue, that holds the cellulose fibres together. Lignin contains both hydrophilic and hydrophobic groups. It is the second most abundant natural polymer in the world, second only to cellulose, and is estimated to represent as much as 20-30% of the total carbon contained in the biomass, which is more than 1 billion tons globally.

The lignosulfonate process introduces large amount of sulfonate groups making the lignin soluble in water but also in acidic water solutions. Lignosulfonates has up to 8% sulfur as sulfonate, whereas kraft lignin has 1-2% sulfur, mostly bonded to the lignin. The molecular weight of lignosulfonate is 15.000-50.000 g/mol. The typical hydrophobic core of lignin together with large number of ionized sulfonate groups make this lignin attractive as a surfactant and it often finds application in dispersing cement etc.

To produce lignin-based value-added products, lignin should be first separated from biomass, for which several methods can be employed. Kraft and sulfite pulping processes are known for their effective lignin separation from wood, and hence, are used worldwide. Kraft lignin is separated from wood with the help of NaOH and Na₂S. Lignins from sulfite pulping processes are denoted as lignosulfonates, and are produced by using sulfurous acid and/or a sulfite salt containing magnesium, calcium, sodium, or ammonium at varying pH levels. Currently, lignosulfonates account for 90% of the total market of commercial lignin, and the total annual worldwide production of lignosulfonates is approximately 1.8 million tons. Lignosulfonates have generally abundance of sulfonic groups, and thus, a higher amount of sulfur than kraft lignin. Due to the presence of the sulfonated group, lignosulfonates are anionically charged and water soluble. The molecular weights (Mw) of lignosulfonates can be similar to or larger than that of kraft lignin. Due to their unique properties, lignosulfonates have a wide range of uses, such as animal feed, pesticides, surfactants, additives in oil drilling, stabilizers in colloidal suspensions, and as plasticizers in concrete admixtures. However, the majority of new pulp mills employ kraft technology for pulp production, and thus, kraft lignin is more readily available for value-added production.

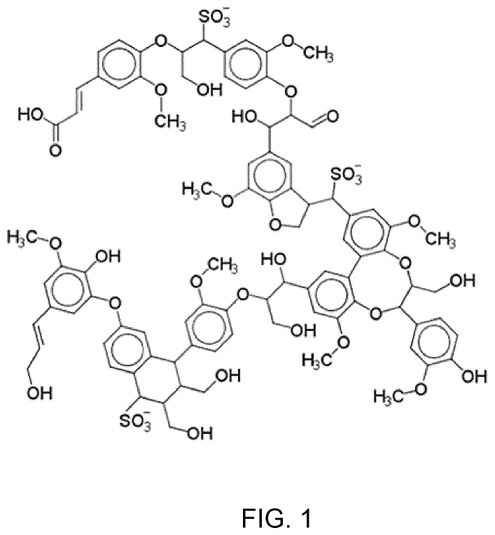

However, lignosulfonates and kraft lignin have different properties coming from different isolation processes and thus distribution of functional groups. High level of sulfonic groups in lignosulfonates, generally at least one for every four C9 units, makes lignosulfonates strongly charged at all pH levels in water. This abundance of ionisable functional groups can explain most of the differences compared to other technical lignins. Higher charge density allows easier water solubility and higher solid content in solution possible compared to kraft lignin. Also, for the same reason, lignosulfonates will have lower solution viscosity compared to kraft lignin at the same solid content which can facilitate handling and processing. Commonly used model structure of lignosulfonates is shown on FIG. 1.

In one embodiment, component (i) is having a carboxylic acid group content of 0.05 to 0.6 mmol/g, such as 0.1 to 0.4 mmol/g, based on the dry weight of lignosulfonate lignins.

In one embodiment, component (i) is in form of one or more lignosulfonate lignins having an average carboxylic acid group content of less than 1.8 groups per macromolecule considering the M_n wt. average of component (i), such as less than 1.4 such as less than 1.1 such as less than 0.7 such as less than 0.4.

In one embodiment, component (i) is having a content of phenolic OH groups of 0.3 to 2.5 mmol/g, such as 0.5 to 2.0 mmol/g, such as 0.5 to 1.5 mmol/g. based on the dry weight of lignosulfonate lignins.

In one embodiment, component (i) is having a content of aliphatic OH groups of 1.0 to 8.0 mmol/g, such as 1.5 to 6.0 mmol/g, such as 2.0 to 5.0 mmol/g, based on the dry weight of lignosulfonate lignins.

In one embodiment, component (i) comprises ammoniumlignosulfonates and/or calciumlignosulfonates, and/or magnesiumlignosulfonates, and any combinations thereof.

In one embodiment, component (i) comprises ammoniumlignosulfonates and calciumlignosulfonates, wherein the molar ratio of NH₄⁺ to Ca₂⁺ is in the range of 5:1 to 1:5, in particular 3:1 to 1:3.

For the purpose of the present invention, the term lignosulfonates encompasses sulfonated kraft lignins.

In one embodiment, component (i) is a sulfonated kraft lignin.

In one embodiment, the aqueous binder composition contains added sugar in an amount of 0 to 5 wt.-%, such as less than 5 wt.-%, such as 0 to 4.9 wt.-%, such as 0.1 to 4.9 wt.-%, based on the weight of lignosulfonate and sugar.

In one embodiment, the aqueous binder composition comprises component (i), i.e. the lignosulfonate, in an amount of 50 to 98 wt.-%, such as 65 to 98 wt.-%, such as 80 to 98 wt.-%, based on the total weight of components (i) and (ii).

In one embodiment, the aqueous binder composition comprises component (i) in an amount of 50 to 98 wt.-%, such as 65 to 98 wt.-%, such as 80 to 98 wt.-%, based on the dry weight of components (i), (ii), and (iii).

For the purpose of the present invention, content of lignin functional groups is determined by using ³¹P NMR as characterization method.

Sample preparation for ³¹P NMR is performed by using 2-chloro-4,4,5,5-tetramethyl-1,3,2-dioxaphospholane (TMDP) as phosphitylation reagent and cholesterol as internal standard. Integration is according to the work of Granata and Argyropoulos (J. Agric. Food Chem. 43:1538-1544).

### Component (ii)

Component (ii) is in form of one or more cross-linkers.

In one embodiment, the component (ii) comprises in one embodiment one or more cross-linkers selected from β-hydroxyalkylamide-cross-linkers and/or oxazoline-cross-linkers.

β-hydroxyalkylamide-cross-linkers is a curing agent for the acid-functional macromolecules. It provides a hard, durable, corrosion resistant and solvent resistant cross-linked polymer network. It is believed the β-hydroxyalkylamide cross-linkers cure through esterification reaction to form multiple ester linkages. The hydroxy functionality of the β-hydroxyalkylamide-cross-linkers should be an average of at least 2, preferably greater than 2 and more preferably 2-4 in order to obtain optimum curing response.

Oxazoline group containing cross-linkers are polymers containing one of more oxazoline groups in each molecule and generally, oxazoline containing cross-linkers can easily be obtained by polymerizing an oxazoline derivative. The patent U.S. Pat. No. 6,818,699 B2 provides a disclosure for such a process.

In one embodiment, the component (ii) is one or more epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, such as β-hydroxyalkylamide groups.

In one embodiment, component (ii) is one or more cross-linkers selected from the group consisting of fatty amines.

In one embodiment, component (ii) is one or more cross-linkers in form of fatty amides.

In one embodiment, component (ii) is one or more cross-linkers selected from polyester polyols, such as polycaprolactone.

In one embodiment, component (ii) is one or more cross-linkers selected from the group consisting of starch, modified starch, CMC.

In one embodiment, component (ii) is one or more cross-linkers in form of multifunctional carbodiimides, such as aliphatic multifunctional carbodiimides.

In one embodiment, the component (ii) is one or more cross-linkers in form of aziridines, such as CX100, NeoAdd-Pax 521/523.

In one embodiment, component (ii) is one or more cross-linkers selected from melamine based cross-linkers, such as a hexakis(methylmethoxy)melamine (HMMM) based cross-linkers.

Examples of such compounds are Picassian XL 701, 702, 725 (Stahl Polymers), such as ZOLDINE® XL-29SE (Angus Chemical Company), such as CX300 (DSM), such as Carbodilite V-02-L2 (Nisshinbo Chemical Inc.).

In one embodiment, component (ii) is Primid XL552, which has the following structure:

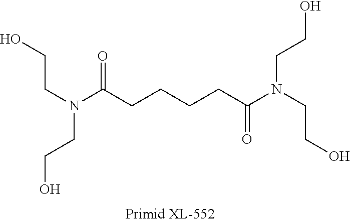 [SMILES: O=C(CCCCC(=O)N(CCO)CCO)N(CCO)CCO]

Component (ii) can also be any mixture of the above mentioned compounds.

In one embodiment, the binder composition according to the present invention comprises component (ii) in an amount of 1 to 50 wt.-%, such as 4 to 20 wt.-%, such as 6 to 12 wt.-%, based on the dry weight of component (i).

In one embodiment, component (ii) is in form of one or more cross-linkers selected from
β-hydroxyalkylamide-cross-linkers, such as N-(2-hydroxyisopropyl)amide-cross-linkers, such as N-(2-hydroxyethyl)amide-cross-linkers, such as N-(2-hydroxyethyl)adipamide-cross-linkers, such as N, N, N′,N′-tetrakis(2-hydroxyethyl)adipamide and/or
the group consisting of multifunctional organic amines such as an alkanolamine, diamines, such as hexamethyldiamine, and/or
epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, and/or
one or more cross-linkers in form of multifunctional carbodiimides, such as aliphatic multifunctional carbodiimides.

In one embodiment, component (ii) comprises one or more cross-linkers selected from
β-hydroxyalkylamide-cross-linkers, such as N-(2-hydroxyisopropyl)amide-cross-linkers, such as N-(2-hydroxyethyl)amide-cross-linkers, such as N-(2-hydroxyethyl)adipamide-cross-linkers, such as N,N,N′,N′-tetrakis(2-hydroxyethyl)adipamide.

In one embodiment, component (ii) comprises component (ii) in an amount of 2 to 90 wt.-%, such as 6 to 60 wt.-%, such as 10 to 40 wt.-%, such as 25 to 40 wt.-%, based on the dry weight of component (i).

Component (iii)

Optionally, the binder composition may comprise a component (iii). Component (iii) is in form of one or more plasticizers.

In one embodiment, component (iii) is in form of one or more plasticizers selected from the group consisting of polyols, such as carbohydrates, hydrogenated sugars, such as sorbitol, erythriol, glycerol, monoethylene glycol, polyethylene glycols, polyethylene glycol ethers, polyethers, phthalates and/or acids, such as adipic acid, vanillic acid, lactic acid and/or ferullic acid, acrylic polymers, polyvinyl alcohol, polyurethane dispersions, ethylene carbonate, propylene carbonate, lactones, lactams, lactides, acrylic based polymers with free carboxy groups and/or polyurethane dispersions with free carboxy groups, polyamides, amides such as carbamide/urea, or any mixtures thereof.

In one embodiment, component (iii) is in form of one or more plasticizers selected from the group consisting of carbonates, such as ethylene carbonate, propylene carbonate, lactones, lactams, lactides, compounds with a structure similar to lignin like vanillin, acetosyringone, solvents used as coalescing agents like alcohol ethers, polyvinyl alcohol.

In one embodiment, component (iii) is in form of one or more non-reactive plasticizer selected from the group consisting of polyethylene glycols, polyethylene glycol ethers, polyethers, hydrogenated sugars, phthalates and/or other esters, solvents used as coalescing agents like alcohol ethers, acrylic polymers, polyvinyl alcohol.

In one embodiment, component (iii) is one or more reactive plasticizers selected from the group consisting of carbonates, such as ethylene carbonate, propylene carbonate, lactones, lactams, lactides, di- or tricarboxylic acids, such as adipic acid, or lactic acid, and/or vanillic acid and/or ferulic acid, polyurethane dispersions, acrylic based polymers with free carboxy groups, compounds with a structure similar to lignin like vanillin, acetosyringone.

In one embodiment, component (iii) is in form of one or more plasticizers selected from the group consisting of fatty alcohols, monohydroxy alcohols such as pentanol, stearyl alcohol.

In one embodiment, component (iii) comprises one or more plasticizers selected from the group consisting of polyethylene glycols, polyethylene glycol ethers, and/or one or more plasticizers in form of polyols, such as 1,1,1-Tris(hydroxymethyl)propane, and/or triethanolamine.

Another particular surprising aspect of the present invention is that the use of plasticizers having a boiling point of more than 100° C., in particular 140 to 250° C., strongly improves the mechanical properties of the growth substrate according to the present invention although, in view of their boiling point, it is likely that these plasticizers will at least in part evaporate during the curing of the binders in contact with the MMVF.

In one embodiment, component (iii) comprises one or more plasticizers having a boiling point of more than 100° C., such as 110 to 380° C., more preferred 120 to 300° C., more preferred 140 to 250° C.

It is believed that the effectiveness of these plasticizers in the binder composition according to the present invention is associated with the effect of increasing the mobility of the lignins during the curing process. It is believed that the increased mobility of the lignins during the curing process facilitates the effective cross-linking.

In one embodiment, component (iii) comprises one or more polyethylene glycols having an average molecular weight of 150 to 50000 g/mol, in particular 150 to 4000 g/mol, more particular 150 to 1000 g/mol, preferably 150 to 500 g/mol, more preferably 200 to 400 g/mol.

In one embodiment, component (iii) comprises one or more polyethylene glycols having an average molecular weight of 4000 to 25000 g/mol, in particular 4000 to 15000 g/mol, more particular 8000 to 12000 g/mol.

In one embodiment component (iii) is capable of forming covalent bonds with component (i) and/or component (ii) during the curing process. Such a component would not evaporate and remain as part of the composition but will be effectively altered to not introduce unwanted side effects e.g. water absorption in the cured product. Non-limiting examples of such a component are caprolactone and acrylic based polymers with free carboxyl groups.

In one embodiment, component (iii) is selected from the group consisting of fatty alcohols, monohydroxy alcohols, such as pentanol, stearyl alcohol.

In one embodiment, component (iii) is selected from one or more plasticizers selected from the group consisting of alkoxylates such as ethoxylates such as butanol ethoxylates, such as butoxytriglycol.

In one embodiment, component (iii) is selected from one or more propylene glycols.

In one embodiment, component (iii) is selected from one or more glycol esters.

In one embodiment, component (iii) is selected from one or more plasticizers selected from the group consisting of adipates, acetates, benzoates, cyclobenzoates, citrates, stearates, sorbates, sebacates, azelates, butyrates, valerates.

In one embodiment, component (iii) is selected from one or more plasticizers selected from the group consisting of phenol derivatives such as alkyl or aryl substituted phenols.

In one embodiment, component (iii) is selected from one or more plasticizers selected from the group consisting of silanols, siloxanes.

In one embodiment, component (iii) is selected from one or more plasticizers selected from the group consisting of sulfates such as alkyl sulfates, sulfonates such as alkyl aryl sulfonates such as alkyl sulfonates, phosphates such as tripolyphosphates; such as tributylphosphates.

In one embodiment, component (iii) is selected from one or more hydroxy acids.

In one embodiment, component (iii) is selected from one or more plasticizers selected from the group consisting of monomeric amides such as acetamides, benzamide, fatty acid amides such as tall oil amides.

In one embodiment, component (iii) is selected from one or more plasticizers selected from the group consisting of quaternary ammonium compounds such as trimethylglycine, distearyldimethylammoniumchloride.

In one embodiment, component (iii) is selected from one or more plasticizers selected from the group consisting of vegetable oils such as castor oil, palm oil, linseed oil, tall oil, soybean oil.

In one embodiment, component (iii) is in form of tall oil.

In one embodiment, component (iii) is selected from one or more plasticizers selected from the group consisting of hydrogenated oils, acetylated oils.

In one embodiment, component (iii) is selected from one or more fatty acid methyl esters.

In one embodiment, component (iii) is selected from one or more plasticizers selected from the group consisting of alkyl polyglucosides, gluconamides, aminoglucoseamides, sucrose esters, sorbitan esters.

In one embodiment, component (iii) is selected from the group consisting of polyethylene glycols, polyethylene glycol ethers.

In one embodiment, component (iii) is selected from the group consisting of triethanolamine.

In one embodiment, component (iii) is in form of propylene glycols, phenol derivatives, silanols, siloxanes, hydroxy acids, vegetable oils, polyethylene glycols, polyethylene glycol ethers, and/or one or more plasticizers in form of polyols, such as 1,1,1-Tris(hydroxymethyl)propane, triethanolamine, or any mixtures thereof.

It has surprisingly been found that the inclusion of plasticizers in the binder compositions according to the present invention strongly improves the mechanical properties of the growth substrate product according to the present invention.

The term plasticizer refers to a substance that is added to a material in order to make the material softer, more flexible (by decreasing the glass-transition temperature Tg) and easier to process.

Component (iii) can also be any mixture of the above mentioned compounds.

In one embodiment, component (iii) is present in an amount of 0.5 to 60, preferably 2.5 to 25, more preferably 3 to 15 wt.-%, based on the dry weight of component (i).

In one embodiment, component (iii) is present in an amount of 0.5 to 60, preferably 2.5 to 25, more preferably 3 to 15 wt.-%, based on the dry weight of components (i), (ii), and (iii).

Binder Composition Comprising Components (i) and (iia)

In one embodiment, the present invention is directed to a method of draining water comprising the steps of:
providing a water drainage device, wherein the water drainage device comprises man-made vitreous fibres (MMVF) bonded with a cured aqueous binder composition free of phenol and formaldehyde;
positioning the water drainage device in contact with the ground, wherein the water drainage device absorbs water and releases water to a recipient;

wherein the aqueous binder composition prior to curing comprises;
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins.
a component (iia) in form of one or more modifiers,

preferably with the proviso that the aqueous binder composition does not comprise a cross-linker selected from
epoxy compounds having a molecular weight Mw of 500 or less, and/or with the proviso that the aqueous binder composition does not comprise a cross-linker selected from
carbonyl compounds selected from aldehydes, carbonyl compounds of the formula R—[C(O)R₁]ₓ

in which:

R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups, R₁ represents a hydrogen atom or a C₁-C₁₀ alkyl radical, and x varies from 1 to 10,

and/or with the proviso that the aqueous binder composition does not comprise a cross-linker selected from
polyamines, and/or with the proviso that the aqueous binder composition does not comprise a cross-linker selected from
mono- and oligosaccharides.

The present inventors have found that the excellent binder properties can also be achieved by a two-component system which comprises component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins and a component (iia) in form of one or more modifiers, and optionally any of the other components mentioned above and below.

In one embodiment, component (iia) is a modifier in form of one or more compounds selected from the group consisting of epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups such as β-hydroxyalkylamide groups.

In one embodiment, component (iia) is one or more modifiers selected from the group consisting of polyethylene imine, polyvinyl amine, fatty amines.

In one embodiment, the component (iia) is one or more modifiers selected from multifunctional carbodiimides, such as aliphatic multifunctional carbodiimides.

Component (iia) can also be any mixture of the above mentioned compounds.

Without wanting to be bound by any particular theory, the present inventors believe that the excellent binder properties achieved by the binder composition for MMVF comprising components (i) and (iia), and optional further components, are at least partly due to the effect that the modifiers used as components (iia) at least partly serve the function of a plasticizer and a cross-linker.

In one embodiment, the binder composition comprises component (iia) in an amount of 1 to 40 wt.-%, such as 4 to 20 wt.-%, such as 6 to 12 wt.-%, based on the dry weight of the component (i).

### Further Components

In some embodiments, the binder composition according to the invention comprises further components.

In one embodiment, the binder composition comprises a catalyst selected from inorganic acids, such as sulfuric acid, sulfamic acid, nitric acid, boric acid, hypophosphorous acid, and/or phosphoric acid, and/or any salts thereof such as sodium hypophosphite, and/or ammonium salts, such as ammonium salts of sulfuric acid, sulfamic acid, nitric acid, boric acid, hypophosphorous acid, and/or phosphoric acid, and/or sodium polyphosphate (STTP), and/or sodium metaphosphate (STMP), and/or phosphorous oxychloride. The presence of such a catalyst can improve the curing properties of the binder compositions according to the present invention.

In one embodiment, the binder composition comprises a catalyst selected from Lewis acids, which can accept an electron pair from a donor compound forming a Lewis adduct, such as ZnCl₂, Mg (ClO₄)₂, Sn [N(SO₂-n-C₈F₁₇)₂]₄.

In one embodiment, the binder composition comprises a catalyst selected from metal chlorides, such as KCl, MgCl₂, ZnCl₂, FeCl₃ and SnCl₂ or their adducts such as AlCl₃ adducts, such as BF₃ adducts, such as BF₃ ethylamine complex.

In one embodiment, the binder composition comprises a catalyst selected from organometallic compounds, such as titanate-based catalysts and stannum based catalysts.

In one embodiment, the binder composition comprises a catalyst selected from chelating agents, such as transition metals, such as iron ions, chromium ions, manganese ions, copper ions and/or from peroxides such as organic peroxides such as dicumyl peroxide.

In one embodiment, the binder composition according to the present invention comprises a catalyst selected from phosphites such as alkyl phosphites, such as aryl phosphites such as triphenyl phosphite.

In one embodiment, the binder composition according to the present invention comprises a catalyst selected from the group of ternary amines such as tris-2,4,6-dimethylaminomethyl phenol.

In one embodiment, the binder composition further comprises a further component (iv) in form of one or more silanes.

In one embodiment, the binder composition comprises a further component (iv) in form of one or more coupling agents, such as organofunctional silanes.

In one embodiment, component (iv) is selected from group consisting of organofunctional silanes, such as primary or secondary amino functionalized silanes, epoxy functionalized silanes, such as polymeric or oligomeric epoxy functionalized silanes, methacrylate functionalized silanes, alkyl and aryl functionalized silanes, urea funtionalised silanes or vinyl functionalized silanes.

In one embodiment, the binder composition further comprises a component (v) in form of one or more components selected from the group of bases, such as ammonia, such as alkali metal hydroxides, such as KOH, such as earth alkaline metal hydroxides, such as Ca(OH)₂, such as Mg(OH)₂, such as amines or any salts thereof.

In one embodiment, the binder composition further comprises a further component in form of urea, in particular in an amount of 5 to 40 wt.-%, such as 10 to 30 wt.-%, 15 to 25 wt.-%, based on the dry weight of component (i).

In one embodiment, the binder composition further comprises a further component in form of one or more carbohydrates selected from the group consisting of sucrose, reducing sugars, in particular dextrose, polycarbohydrates, and mixtures thereof, preferably dextrins and maltodextrins, more preferably glucose syrups, and more preferably glucose syrups with a dextrose equivalent value of DE=30 to less than 100, such as DE=60 to less than 100, such as DE=60-99, such as DE=85-99, such as DE=95-99.

In one embodiment, the binder composition further comprises a further component in form of one or more carbohydrates selected from the group consisting of sucrose and reducing sugars in an amount of 5 to 50 wt.-%, such as 5 to less than 50 wt.-%, such as 10 to 40 wt.-%, such as 15 to 30 wt.-% based on the dry weight of component (i). In the context of the present invention, a binder composition having a sugar content of 50 wt.-% or more, based on the total dry weight of the binder components, is considered to be a sugar based binder. In the context of the present invention, a binder composition having a sugar content of less than 50 wt.-%, based on the total dry weight of the binder components, is considered a non-sugar based binder.

In one embodiment, the binder composition further comprises a further component in form of one or more surface active agents that are in the form of non-ionic and/or ionic emulsifiers such as polyoxyethylenes (4) lauryl ether, such as soy lecithin, such as sodium dodecyl sulfate.

In one embodiment, the aqueous binder composition consists essentially of
a component (i) in form of one or more lignins selected from the group of lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,

and/or
a component (ii) in form of one or more cross-linkers;
a component (iii) in form of one or more plasticizers;
a component (iv) in form of one or more coupling agents, such as organofunctional silanes;
optionally a component in form of one or more compounds selected from the group of bases, such as ammonia, such as alkali metal hydroxides, such as KOH, such as earth alkaline metal hydroxides, such as Ca(OH)₂, such as Mg(OH)₂, such as amines or any salts thereof;
optionally a component in form of urea;
optionally one or more surface active agents;
water.

In one embodiment, the aqueous binder composition consists essentially of
a component (i) in form of one or more lignins selected from the group of lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins, and/or
a component (ii) in form of one or more cross-linkers;
a component (iv) in form of one or more coupling agents, such as organofunctional silanes;
optionally a component in form of one or more compounds selected from the group of bases, such as ammonia, such as alkali metal hydroxides, such as KOH, such as earth alkaline metal hydroxides, such as Ca(OH)₂, such as Mg(OH)₂, such as amines or any salts thereof;
optionally a component in form of urea;
optionally one or more surface active agents;
water.

The present inventors have surprisingly found that a coherent growth substrate product comprising man-made vitreous fibres (MMVF) bonded with a cured aqueous binder composition as it is described above have at a very high stability, both when freshly produced and after aging conditions.

Further, the present inventors have found that even higher product stability can be obtained by using a curing temperature of >230° C.

The present inventors have further found that the stability of the growth substrate product can be further increased by the following measures:
Lower line capacity, meaning longer curing time
Addition of high amounts of crosslinker
Addition of a combination of two or more different crosslinkers
Addition of small amounts of cationic species such as multivalent metal ions such as calcium and/or organic cationic species such as amines and/or organically modified inorganic compounds such as amine modified montmorillonite clays

In the method of the invention, the water drainage device is positioned in contact with the ground and is preferably at least partially buried within the ground. Preferably the water drainage device is completely buried in the ground, for example completely covered with earth. Earth includes sediment, sand, clay, dirt, gravel and the like. For example, the water drainage device may be buried under at least 20 cm of earth, preferably at least 40 cm of earth, most preferably at least 50 cm of earth.

In the method of the invention, the water drainage device absorbs water and releases water to a recipient. The device may absorb water directly from the surrounding ground or it may be conveyed to the device by some means, for example, a pipe. The device can hold the water and then release it to a recipient. The recipient may be the surrounding ground, i.e. water from the device dissipates back into the ground once the ground has become drier. The recipient may also be a water collection point, a reservoir, a tank, a gutter, a drain pipe or a sewer.

Preferably, the water drainage device comprises a first conduit. The first conduit preferably conveys water into the water drainage device. This ensures that water can flow along the first conduit, and directly into the water drainage device. Preferably the first conduit has a first open end and a second open end, wherein the first open end is in fluid communication with the MMVF of the water drainage device. It is, of course envisaged that the water drainage device can butt up against the first conduit, preferably a pipe, through which rain water will flow, in order to achieve this fluid communication. It is preferable however for efficiency for the first conduit to be at least partially embedded into the water drainage device. The embedded part of the first conduit may have an aperture in its outer wall, preferably more than one aperture. The presence of an aperture has the advantage of there being a greater area through which the water can flow into the water drainage device.

The first conduit may be an open channel, and water may flow along this channel into the water drainage device from, for example, a mains drainage system or guttering. Preferably the conduit is a pipe. An advantage of a pipe is that it is hollow and can therefore freely transport water underground to the water drainage device. Further, the wall of the pipe prevents debris from entering the pipe.

Preferably the first conduit, preferably a pipe, is positioned in fluid communication with the bottom section of the water drainage device. This means that on installation, the first conduit is positioned in fluid communication with the bottom half of the water drainage device by volume. This is because, to fill the whole device fast enough, the air that is present in the device before it starts to rain, needs to be expelled. This happens fastest in the above described arrangement.

The conduit, preferably a pipe, is in fluid communication with the water drainage device, and may be in fluid communication with a system of conduits, preferably pipes and one or more drainpipes so that water which flows off a roof, into a gutter, down a drainpipe can be stored within the water drainage device during wet weather. This is in addition to water that the device can absorb from the surrounding ground (i.e. reducing surface water). As the surrounding ground dries out, the water gradually dissipates from the water drainage device into the ground. The water drainage device thus provides an effective way to dispose of rain water which does not put any pressure on existing mains drainage systems. It is not necessary to transport the water elsewhere, although this is possible; the water can be disposed of within the ground. For example, a building may have one, or several, water drainage devices connected to their guttering systems, and thus is able to dispose of this surface water within its own grounds.

The water drainage device may have a passage which extends from a first end of the water drainage device, towards a second end of the water drainage device, wherein the first and second ends are opposed and wherein the first end of the passage is in fluid communication with water from the conduit, preferably a pipe.

The passage may extend 10% to 100% of the way through the water drainage device, preferably 20% to 99% of the way through the water drainage device, preferably 50% to 99% of the way through the water drainage device, more preferably 80% to 95% of the way through the substrate. The advantage of the passage is that there is a greater area through which the water can flow into the water drainage device. The passage may have any cross-sectional shape, preferably circular, triangular or square.

The passage may be formed by embedding the conduit, preferably a pipe, into the water drainage device as described above. The conduit preferably has an aperture in its outer wall, preferably more than one aperture. The presence of an aperture has the advantage of there being a greater area through which the water can flow into the water drainage device.

The passage may be formed by a separate pipe which has at least one aperture. The pipe is preferably a perforated plastic pipe, such as a PVC pipe. The pipe gives strength to the drain and prevents the passage from becoming closed. The pipe is perforated to allow the water to drain into the passage. The embedded pipe provides support to the passage to make it more resilient or resistant to pressure. In the absence of a pipe, the passage could become closed due to pressure on the water drainage device, such as vehicles moving over the water drainage device.

The passage may be formed by removing a section of the water drainage device, such as by drilling. The resulting passage will be porous and thus allow water to be absorbed into the water drainage device from the passage.

The water drainage device may comprise a first part in contact with a second part, wherein the passage is disposed between the first part and the second part. This means that the first part may be preformed with a groove along at least part of the length of the water drainage device, and when the first part and second parts are joined together, the passage is formed by the groove and the second part. Alternatively the second part may have the groove. Alternatively, both the first and second parts may have a groove and the grooves may be lined up to form the passage when the first and second parts are joined together. The groove or grooves may be of any shape as required to form the passage. The groove or grooves may therefore have a cross-section which is semicircular, triangular, rectangular or the like.

The first and second parts of the water drainage device may be joined by placing the two parts together, or using an adhesive.

The passage may be formed by a combination of the means described above.

Preferably the cross-sectional areas of the first and second ends of the passage are in the range 2 to 200 cm², preferably 5 to 100 cm².

Preferably the cross-sectional area of the first end of the passage is 0.5% to 15% of the cross-sectional area of the first end of the water drainage device, preferably 1% to 10%.

Preferably the cross-sectional area of the second end of the passage is 0.5% to 15% of the cross-sectional area of the second end Water drainage device, preferably 1% to 10%.

The openings are such a small percentage of the cross-sectional area of the ends of the water drainage device since the vast majority of the water drainage device is used to buffer the amount of water that is conveyed to the water drainage device. The larger the proportion of the water drainage device, the greater the volume of water that can be buffered by a water drainage device of a given cross-sectional area.

The cross-sectional area of the passage is preferably substantially continuous along its length. Substantially continuous means that the cross-sectional area is within 10% of the average cross-sectional area, preferably within 5%, most preferably within 1%. If necessary however, the cross-sectional area can be varied according to the requirements of the passage to be smaller or larger.

The passage may be straight through the water drainage device, that is, the passage takes the most direct route towards the second end of the water drainage device to allow water to take the most direct route along the passage.

The passage may follow an indirect route through the water drainage device to increase the surface area of the passage so that water can drain into the water drainage device at a faster rate.

There may be more than one passage through the water drainage device to increase the surface area of the passage so that water can drain into the Water drainage device at a faster rate. Where there is more than one passage, the passages are preferably connected to form a network of passages so that water may flow through the network of passages. Each passage may be in fluid communication with a different conduit thus allowing water from different sources to be disposed of by the water drainage device.

There may be passages in the bottom as well as in the top of the water drainage device. An advantage of having passages in the top and in the bottom is that while water enters via the bottom passage, all the air that is present in the device before it starts filling with water is able to vent out via the top passage in the device.

The passage may have a triangular cross-section. When installed, the base of the triangle is preferably parallel with the base of the water drainage device. Alternatively the passage can have a semicircular cross-section. Again, the base of the water drainage device is preferably parallel with the base of the semicircle. Alternatively, the passage can have a circular or a rectangular cross-section. The advantage of these passage cross-sections is that the largest surface area of the passage is at the lowest point which gives the largest surface area for the water to flow through.

The passage is preferably positioned centrally in the width of the cross-section of the water drainage device. The reason that this is substantially centrally, is so that the flow of the water which is to be absorbed will be down the centre of the water drainage device. This has the advantage that the strength of the water drainage device is maintained at the sides of the water drainage device. If however the passage was arranged close to one side of the water drainage device, this may cause a weakness in the structure.

In use, when the passage extends from the first end to the second end of the water drainage device, the second end of the passage is preferably closed to prevent earth from entering the passage and reducing the size of the passage. The second end of the passage may be closed by arranging a plate over the opening, such as an MMVF plate, a metal plate, a plastic plate or the like. Alternatively, the second end of the passage may be plugged, such as with a plug made from MMVF, metal, plastic or the like. The second end may be wrapped in a geo-textile material to close the second end of the passage.

An advantage of using the water drainage device according to the invention is that it can absorb water from the ground and store it within its open pore structure. The water drainage device can also convey water along the optional passage towards the second opening. This means that the water drainage device can store water when required, and also convey water to a recipient e.g. disposal means when required.

In this use, the water drainage device will be installed to drain waterlogged ground, particularly when precipitation such as rain, snow, sleet, hail and the like results in surface water which causes the ground to become waterlogged. This can commonly occur near to buildings, particularly where a portion of the surrounding ground is covered by buildings, paving, tarmac or the like without adequate drainage. If there is not adequate drainage, this puts pressure on the ground surrounding this area to dissipate the surface water that has accumulated. This results in the surrounding area becoming waterlogged and needing to be drained.

A further advantage of using the device of the present invention is that it delays water reaching a water collection point, such as a tank or a reservoir. When there is heavy rainfall, a reservoir or tank may become overwhelmed by a sudden rush of water. Using a device according to the present invention delays the arrival of the rush of water at the reservoir or tank and thus helps prevent flooding.

As discussed above, the water drainage device need not have any conduits and can act as a drainage device by absorbing excess water from the surrounding ground in times of high water levels, and releasing the water back into the ground at times of low water levels. In this way, the water drainage device of the present invention can be used to drain the waterlogged ground. This can be by absorbing the excess water into the open pore structure of the water drainage device and storing the water until the ground dries out and then gradually dissipating the water to the ground.

The water drainage device may optionally have a first conduit and a second conduit. The first conduit conveys water to the water drainage device and is preferably positioned in the bottom half of the device. The second conduit is preferably positioned in the top half of the device. The second conduit has the primary purpose of expelling air from the device. However, it can also function as an overflow. This means that when the device is saturated with water, the second conduit conveys water to a water storage tank, mains drainage or water drain reservoir.

Alternatively, the first conduit and the second conduit may be connected by a passage as discussed above. The water logged ground is drained by water being conveyed along the passage of the water drainage device towards the second opening and to a disposal system, such as a tank, mains drainage or a water drain reservoir. If there is a low level of excess water in the ground, the water drainage device can store this excess water until the ground is dry enough to dissipate the water back to the ground. If there is a high level of excess water, this can be conveyed along the passage to a disposal system.

The water can be conveyed by gravity along the optional passage, for example, by installing the water drainage device with a slope such that the second end of the water drainage device is lower than the first end of the water drainage device. Preferably the angle of the slope is 2 to 10 degrees from horizontal. An advantage of installing the drain with a slope is that it is not necessary to pump the water from the drain element.

Alternatively, a pump can be in fluid communication with the second opening of the passage, wherein the pump conveys water towards the second opening of the passage. The pump may be in fluid communication with the second opening by a conduit, such as a pipe. The water can be pumped along the passage to a water disposal system such as a tank, mains drainage or a water drain reservoir. An advantage of using a pump is that the drain element can be installed without a slope and therefore on installation it is not necessary to dig deeper at one end of the installation.

It is possible to have both a water drainage device installed on a slope and a pump system.

In use, the passage is preferably offset towards a first direction and the water drainage device is oriented such that the first direction is down. It is advantageous for the passage to be at the bottom of the water drainage device.

Preferably the water holding capacity of the water drainage device is at least 80% of the volume, preferably 80-99%, most preferably 85-95%. The greater the water holding capacity, the more water that can be stored for a given volume. The water holding capacity of the water drainage device is high due to the open pore structure and the hydrophilicity.

Preferably the amount of water that is retained by the water drainage device when it gives off water is less than 20% vol, preferably less than 10% vol, most preferably less than 5% vol. The water retained may be 2 to 20% vol, such as 5 to 10% vol. The lower the amount of water retained by the water drainage device, the greater the capacity of the water drainage device to take on more water. Water may leave the water drainage device by dissipating into the ground when the surrounding ground is dry and the capillary balance is such that the water dissipates into the ground.

Preferably the buffering capacity of the water drainage device, that is the difference between the maximum amount of water that can be held, and the amount of water that is retained when the water drainage device gives off water is at least 60% vol, preferably at least 70% vol, preferably at least 80% vol. The buffering capacity may be 60 to 90% vol, such as 60 to 85% vol. The advantage of such a high buffering capacity is that the water drainage device can buffer more water for a given volume, that is the water drainage device can store a high volume of water when it rains, and release a high volume of water as the surrounding ground dries out. The buffering capacity is so high because the water drainage device requires a low suction pressure to remove water from it.

The water holding capacity, the amount of water retained and the buffering capacity of the water drainage device can be measured in accordance with EN 13041: 1999.

The water is stored in the water drainage device when the surrounding ground is saturated, that is the capillary balance means that the water is retained within the water drainage device. As the surrounding ground dries out, the capillary balance shifts, and the water dissipates from the water drainage device into the surrounding ground. In this way, water is held within the water drainage device when the surrounding ground is saturated. When the surrounding ground dries out, the water dissipates from the water drainage device into the ground. The water drainage device is then able to take on more water, for example via a pipe or conduit.

The structure of the water drainage device is such that whilst water can dissipate from the substrate into the ground, earth does not contaminate the water drainage device. This is due to the small pore size within the water drainage device. It is therefore not necessary to wrap the water drainage device in a geo-textile to prevent contamination. This has the advantage that on installation, the water drainage device does not have to be manually wrapped in a geo-textile material by the installer. The wrapping step of the other water drain devices is awkward and time consuming, since it is performed at the installation stage. The water drain device of this invention does not have this problem.

The water drainage device may comprise a force distribution layer. Preferably the force distribution layer is positioned at the top face of the water drainage device in use.

The force distribution layer may be a coherent MMVF layer. When the force distribution layer is a coherent MMVF layer, it preferably has a compressive strength of at least 200 kPa, and the compressive strength may be up to 1 MPa. Preferably, it is 200 to 500 kPa, more preferably 300 to 400 kPa. The compressive strength is measured according to European Standard EN 826:1996. Force distribution layers with such a compressive strength are particularly suitable for use in the present invention as they ensure that force impacting from the ground surface is not concentrated on a single point of the drainage device, but is instead distributed over a larger area.

When the force distribution layer is a coherent MMVF layer, it preferably has a density of at least 100 kg/m³, such as 100 to 280 kg/m³, preferably 150 to 200 kg/m³, and the density may be up to 600 kg/m³. Force distribution layers with such a density are particularly suitable for use in the present invention as they ensure that force impacting from the ground surface is not concentrated on a single point, but is instead distributed over a larger area.

When the force distribution layer is a coherent MMVF layer, it is preferably hydrophilic, that is it attracts water. The MMVF layer is in the form of a coherent mass. That is, the MMVF layer is generally a coherent matrix of MMVF fibres, which has been produced as such, but can also be formed by granulating a slab of MMVF and consolidating the granulated material.

The water drainage device can further comprise an upper layer above the force distribution layer. The upper layer is preferably grass, earth, artificial grass, sand, gravel, clay or combinations thereof.

In one embodiment, the water drainage device may further comprise a liquid impermeable covering. Preferably the liquid impermeable covering surrounds the water drainage device. The liquid impermeable covering may comprise one or more openings at the location of any conduit. For example, the liquid impermeable covering may comprise a first opening for the first conduit described herein. It may also comprise a second opening for the second conduit described herein. This is to allow water to flow into the device or out of the device through the conduits. However, water is prevented from exiting the device at locations other than the conduits due to the liquid impermeable covering.

This covering has been found to be advantageous when the water drainage device is installed in locations where it is undesirable for infiltration of water into the surrounding ground to occur. This can be required for governmental regulations.

For example, rain water which has been collected via a drainage system from hard surfaces such as roads or car parks is considered to be “polluted” water. This is due to the residues on the hard surface, such as petrol, diesel and heavy metals, which may be carried by the water. It is undesirable for such water to be dispersed into the surrounding ground, but the water drainage device of the present invention is able to prevent flooding by holding the excess water and transporting it safely via conduits to a water disposal point.

Furthermore, it may also be undesirable for water to dissipate into the surrounding ground from the water drainage device when the surrounding ground itself is unsuitable for infiltration. This may be due to the surrounding ground being polluted, and as such dissipating water would cause the polluted elements in the ground to be dispersed. It may also be because the ground is not able to absorb water, for example if it contains a high amount of clay. Again, the water drainage device of the present invention is able to prevent flooding by holding the excess water and transporting it safely via conduits to a water disposal point.

The liquid impermeable covering according to the invention may comprise a material selected from the following list: thermoplastic, thermosetting plastic, elastomer, natural polymer, synthetic polymer, foil, such as foil used in agriculture, bentonite, clay, compressed MMVF or any other known plastic. The liquid impermeable covering according to the invention may comprise poly (p-phenylene ether) (PPE), polyethylene (PE), polyvinyl chloride (PVC) or ethylene propylene diene monomer (EPDM).

The liquid impermeable covering may also be called a wrapping or a sleeve. The water drainage device may comprise one or more layers of liquid impermeable covering.

The present invention is also directed to a water drainage device comprising man-made vitreous fibres (MMVF) bonded with a cured aqueous binder composition free of phenol and formaldehyde, wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins, and
a component (ii) in form of one or more cross-linkers.

The water drainage device is as described above. This embodiment may have any of the additional features described above for the method of the invention.

The present invention also relates to an array of at least two water drainage devices, wherein the water drainage devices comprise man-made vitreous fibres (MMVF) bonded with a cured aqueous binder composition free of phenol and formaldehyde, wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins, and
a component (ii) in form of one or more cross-linkers.

In the array according to the invention, the at least two water drainage devices may be identical. Alternatively, the at least two water drainage devices may not be identical.

The array may be at least two water drainage devices positioned beside each other, or in contact with each other so that water can dissipate from one water drainage device to the next. There may be more than two water drainage devices, for example as many devices as are required to fill the desired area.

One or more of the water drainage devices may have any of the additional features described above.

Preferably, one of the at least two water drainage devices comprises a first conduit as described above.

Preferably, the second water drainage device comprises a second conduit, as described above.

Preferably, one of the water drainage devices comprises a first end and a second end and a passage which extends from a first opening in the first end to a second opening in the second end. In the array of the present invention, one or more of the water drainage devices may comprise a passage.

In one embodiment, the first opening of a passage in a first water drainage device may be contacted to the first end of a passage in a second water drainage device. For example, two or more water drainage devices may be in fluid communication with each other by being connected by a passage. The first opening of a passage in a first water drainage device may be in fluid communication with first opening of a passage in a second water drainage device. The second opening of the passage in the first water drainage device may be in fluid communication with a first conduit, bringing water from, for example, gutterings. The second opening of the passage in the second water drainage device may be in fluid communication with a first opening of a passage in a third water drainage device, or may be in fluid communication with a second conduit for transferring water to a water storage tank. In this way, a network of water drainage devices can be arranged, all in fluid communication. Preferably, the passages in two or more water drainage devices are lined up so as to form a longer passage.

The array according to the invention is advantageous as it increases the volume of water that can be stored and then dissipated.

The present invention also relates to use of a water drainage device for draining water, wherein the water drainage device comprising man-made vitreous fibres (MMVF) bonded with a cured aqueous binder composition free of phenol and formaldehyde, wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins, and
a component (ii) in form of one or more cross-linkers.

This embodiment of the invention may have any of the additional features described above for the method of the invention.

The present invention also relates to a method of producing a water drainage device. The method comprises the steps of:
(i) providing man-made vitreous fibres;
(ii) spraying the man-made vitreous fibres with an aqueous binder composition free of phenol and formaldehyde;
(iii) collecting and consolidating the man-made vitreous fibres and curing the aqueous binder composition to form a water drainage device;

wherein the binder composition prior to curing comprises:
a component (i) in form of one or more lignosulfonate lignins having a carboxylic acid group content of 0.03 to 1.4 mmol/g, based on the dry weight of the lignosulfonate lignins, and
a component (ii) in form of one or more cross-linkers.

The water drainage device may have any of the additional features discussed in detail above.

Man-made vitreous fibres can be made from a mineral melt. A mineral melt is provided in a conventional manner by providing mineral materials and melting them in a furnace. This furnace can be any of the types of furnace known for production of mineral melts for MMVF, for instance a shaft furnace such as a cupola furnace, a tank furnace, an electric furnace or a cyclone furnace.

Any suitable method may be employed to form MMVF from the mineral melt by fiberization. The fiberization can be by a spinning cup process in which melt is centrifugally extruded through orifices in the walls of a rotating cup (spinning cup or disk fiberization, also known as internal centrifugation). Alternatively the fiberization can be by centrifugal fiberization by projecting the melt onto and spinning off the outer surface of one fiberizing rotor, or off a cascade of a plurality of fiberizing rotors, which rotate about a substantially horizontal axis (cascade spinner).

The melt is thus formed into a cloud of fibres entrained in air and the fibres are collected as a web on a conveyor and carried away from the fiberizing apparatus. The web of fibres is then consolidated, which can involve cross-lapping and/or longitudinal compression and/or vertical compression and/or winding around a mandrel to produce a cylindrical product for pipe insulation. Other consolidation processes may also be performed.

The binder composition is applied to the fibres preferably when they are a cloud entrained in air. Alternatively it can be applied after collection on the conveyor but this is less preferred.

After consolidation the consolidated web of fibres is passed into a curing device to cure the binder.

Generally, the binder is sprayed immediately after fibrillation of the mineral melt on to the air-borne mineral fibres. The aqueous binder composition is normally applied in an amount of 0.1 to 18%, preferably 0.2 to 8% by weight, of the bonded MMVF product on a dry basis.

After consolidation the consolidated web of fibres is preferably passed into a curing device to cure the binder. The spray-coated mineral fibre web is generally cured in a curing oven by means of a hot air stream. The hot air stream may be introduced into the mineral fibre web from below, or above or from alternating directions in distinctive zones in the length direction of the curing oven. The web is cured by a chemical and/or physical reaction of the binder components

In one embodiment, the curing is carried out at temperatures from 100 to 300° C., such as 170 to 270° C., such as 180 to 250° C., such as 190 to 230° C. Preferably the step of curing occurs at a curing temperature of >230° C.

The present inventors have surprisingly found that MMVF cured with an aqueous binder composition as it is described above have a very high stability, both when freshly produced and after aging conditions.

Further, the present inventors have found that even higher product stability can be obtained by using a curing temperature of >230° C.

In a preferred embodiment, the curing takes place in a conventional curing oven for mineral wool production, preferably operating at a temperature of from 150 to 300° C., such as 170 to 270° C., such as 180 to 250° C., such as 190 to 230° C.

In one embodiment, the curing takes place for a time of 30 seconds to 20 minutes, such as 1 to 15 minutes, such as 2 to 10 minutes.

The curing process may commence immediately after application of the binder to the fibres. The curing is defined as a process whereby the binder composition undergoes a physical and/or chemical reaction which in case of a chemical reaction usually increases the molecular weight of the compounds in the binder composition and thereby increases the viscosity of the binder composition, usually until the binder composition reaches a solid state. The cured binder composition binds the fibres to form a structurally coherent matrix of fibres.

In a one embodiment, the curing of the binder in contact with the mineral fibres takes place in a heat press.

The curing of a binder in contact with the mineral fibres in a heat press has the particular advantage that it enables the production of high-density products.

In one embodiment the curing process comprises drying by pressure. The pressure may be applied by blowing air or gas through/over the mixture of mineral fibres and binder.

The present invention also relates to the use of a lignin component in form of one or more lignosulfonate lignins having a carboxylic acid group content of 0.03 to 1.4 mmol/g, based on the dry weight of the lignosulfonate lignins, for the preparation of a binder composition free of phenol and formaldehyde for a water drainage device comprising man-made vitreous fibres (MMVF).

In one embodiment, the binder composition is free of phenol and formaldehyde.

In one embodiment, the present invention is directed to the use of a lignin component in the form of one or more lignosulfonate lignins having the features of component (i) described above for the preparation of a binder composition, preferably free of phenol and formaldehyde, for a coherent growth substrate product comprising man-made vitreous fibres (MMVF), whereby this binder composition further comprises components (ii) and optionally (iii) as defined above, preferably with the proviso that the aqueous binder composition does not comprise a cross-linker selected from
epoxy compounds having a molecular weight Mw of 500 or less

and/or

with the proviso that the aqueous binder composition does not comprise a cross-linker selected from
carbonyl compounds selected from aldehydes, carbonyl compounds of the formula R—[C(O)R₁]ₓ

in which:

R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups,

R₁ represents a hydrogen atom or a C₁-C₁₀ alkyl radical, and x varies from 1 to 10

and/or

with the proviso that the aqueous binder composition does not comprise a cross-linker selected from
polyamines

and/or

with the proviso that the aqueous binder composition does not comprise a cross-linker selected from
mono- and oligosaccharides.

In one embodiment, the present invention is directed to the use of a lignin component in form of one or more lignosulfonate lignins having the features of component (i) described above for the preparation of a binder composition, preferably free of phenol and formaldehyde, whereby the binder composition further comprises component (iia) as defined above.

### DETAILED DESCRIPTION OF FIGURES

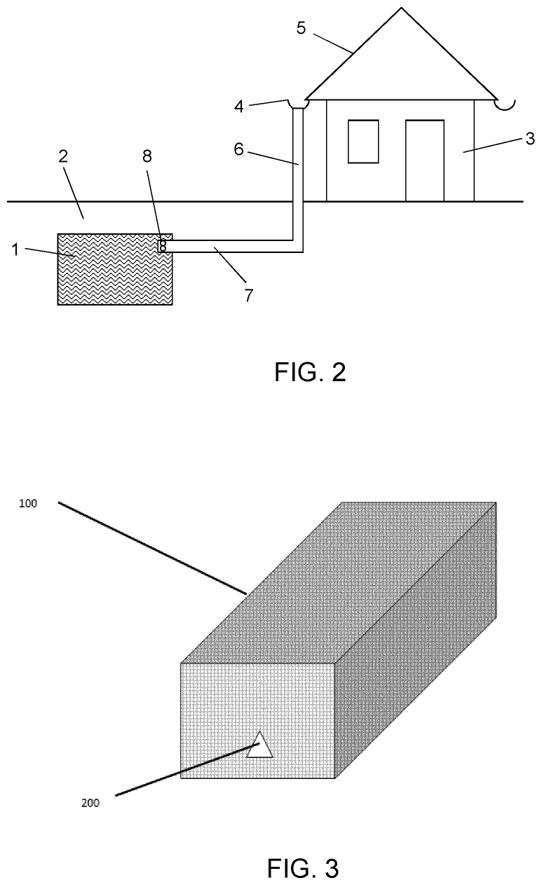

FIG. 2 shows a MMVF water drainage device 1 according to one aspect of the invention that has been dug into the ground 2 in the vicinity of a house 3. The house 3 is provided with gutters 4 that collect water from the roof 5 and lead it to the MMVF water drainage device 1 via a drain pipe 6 and a conduit 7. The conduit 7 is in fluid communication with the MMVF water drainage device 1. The conduit 7 may butt up against the MMVF water drainage device 1, but preferably it is partly embedded in the MMVF water drainage device 1 in order to ensure that debris is not entering the conduit 7. In the part that is embedded in the MMVF water drainage device 1 the conduit 7 may be provided with apertures 8 to increase the fluid communication area between the conduit 7 and the MMVF water drainage device 1.

FIG. 3 shows a water drainage device 100 with a passage 200 which extends from the first end of the MMVF water drainage device to the second end of the MMVF water drainage device. The passage is towards the bottom of the MMVF water drainage device.

### EXAMPLES

In the following examples, several binders which fall under the definition of the present invention were prepared and compared to binders according to the prior art. The following properties were determined for the binders according to the present invention and the binders according to the prior art, respectively:

### Binder Component Solids Content

The content of each of the components in a given binder solution before curing is based on the anhydrous mass of the components.

Lignosulfonates were supplied by Borregaard, Norway and LignoTech, Florida as liquids with approximately 50% solid content. Primid XL552 was supplied by EMS-CHEMIE AG, Silane (Momentive VS-142 40% activity), was supplied by Momentive and was calculated as 100% for simplicity. NH₄OH 24.7% was supplied by Univar and used in supplied form. PEG 200, urea, KOH pellets, 1,1,1 tris(hydroxymethyl)propane were supplied by Sigma-Aldrich and were assumed anhydrous for simplicity.

### Binder Solids

The content of binder after curing is termed “binder solids”.

Disc-shaped stone wool samples (diameter: 5 cm; height 1 cm) were cut out of stone wool and heat-treated at 580° C. for at least 30 minutes to remove all organics. The solids of the binder mixture was measured by distributing a sample of the binder mixture (approx. 2 g) onto a heat treated stone wool disc in a tin foil container. The weight of the tin foil container containing the stone wool disc was weighed before and directly after addition of the binder mixture. Two such binder mixture loaded stone wool discs in tin foil containers were produced and they were then heated at 200° C. for 1 hour. After cooling and storing at room temperature for 10 minutes, the samples were weighed and the binder solids was calculated as an average of the two results.

A binder with a desired binder solids could then be produced by diluting with the required amount of water and 10% aq. silane (Momentive VS-142).

### Example 1: Water Absorption

Water absorption was measured in accordance with EN1609:2013 for four different binder compositions, as shown in Table 1 below. The testing was performed using four individual test specimens in 200×200 mm in full product thickness to get one result

### Comparative Binder 1, a PUF Binder, was Made as Follows:

A phenol-formaldehyde resin is prepared by reacting 37% aq. formaldehyde (606 g) and phenol (189 g) in the presence of 46% aq. potassium hydroxide (25.5 g) at a reaction temperature of 84° C. preceded by a heating rate of approximately 1° C. per minute. The reaction is continued at 84° C. until the acid tolerance of the resin is 4 and most of the phenol is converted. Urea (241 g) is then added and the mixture is cooled.

The acid tolerance (AT) expresses the number of times a given volume of a binder can be diluted with acid without the mixture becoming cloudy (the binder precipitates). Sulfuric acid is used to determine the stop criterion in a binder production and an acid tolerance lower than 4 indicates the end of the binder reaction.

To measure the AT, a titrant is produced from diluting 2.5 ml conc. sulfuric acid (>99%) with 1 L ion exchanged water. 5 mL of the binder to be investigated is then titrated at room temperature with this titrant while keeping the binder in motion by manually shaking it; if preferred, use a magnetic stirrer and a magnetic stick. Titration is continued until a slight cloud appears in the binder, which does not disappear when the binder is shaken.

The acid tolerance (AT) is calculated by dividing the amount of acid used for the titration (mL) with the amount of sample (mL):

AT=(Used titration volume(mL))/(Sample volume(mL))

Using the urea-modified phenol-formaldehyde resin obtained, a binder is made by addition of 25% aq. ammonia (90 mL) and ammonium sulfate (13.2 g) followed by water (1.30 kg).

The binder solids were then measured as described above and the mixture was diluted with the required amount of water and silane (15% binder solids solution, 0.5% silane of binder solids).

### Comparative Binder 2 was Made as Follows:

3267 kg of water is charged in 6000 l reactor followed by 287 kg of ammonia water (24.7%). Then 1531 kg of Lignin UPM BioPiva 100 is slowly added over a period of 30 min to 45 min. The mixture is heated to 40° C. and kept at that temperature for 1 hour. After 1 hour a check is made on insolubilized lignin. This can be made by checking the solution on a glass plate or a Hegman gauge. Insolubilized lignin is seen as small particles in the brown binder. During the dissolution step will the lignin solution change color from brown to shiny black. After the lignin is completely dissolved, 1 liter of a foam dampening agent (Skumdæmper 11-10 from NCÅ-Verodan) is added. Temperature of the batch is maintained at 40° C. Then addition of 307.5 kg 35% hydrogen peroxide is started. The hydrogen peroxide is dosed at a rate of 200-300 I/h. First half of the hydrogen peroxide is added at a rate of 200 l/h where after the dosage rate is increased to 300 l/h.

During the addition of hydrogen peroxide is the temperature in the reaction mixture controlled by heating or cooling in such a way that a final reaction temperature of 65° C. is reached.

The final product was analysed for the COOH group content, dry solid matter, pH, viscosity and remaining H₂O₂·60 g of this oxidized lignin (18.2% solids) was mixed with 1.4 g Primid XL552 (100% solids) and 2.8 g PEG200 (100% solids). 0.6 g Silane (Momentive VS-142 40% activity, 10% in water) and 17.4 g water were added and mixed to yield 15% solids.

### Binder 1, According to the Invention, was Made as Follows:

600.0 kg of ammonium lignosulfonate was placed in a mixing vessel to which 8.0 litres NH₄OH (24,7%) was added and stirred. Afterwards, 190 kg Primid XL552 solution (pre-made 31 wt % solution in water) and 68 kg PEG 200 (100% solids) were added and mixed followed by addition of 11 kg Silane (Momentive VS-142 40% activity, 10% in water).

### Binder 2, According to the Invention, was Made as Follows:

730.0 kg of ammonium lignosulfonate was placed in a mixing vessel to which 8.5 l NH₄OH (24,7%) was added and stirred. Afterwards, 151 kg Primid XL552 solution (pre-made 31 wt % solution in water) and 43 kg PEG 200 (100% solids) were added and mixed followed by addition of 13 kg Silane (Momentive VS-142 40% activity, 10% in water).

The results are shown below in Table 1.

As can be seen from Table 1, the water absorption for binders according to the invention is significantly higher than for the PUF binder or for the comparative lignin-based formaldehyde free binder.

TABLE 1

| Binder | water abs kg/m2 24 h |
|---|---|
| Comparative Binder 1 (PUF) | 0.10 |
| Comparative Binder 2 (lignin based | 0.20 |
| Formaldehyde free) | |
| Binder 1 | 0.60 |
| Binder 2 | 0.70 |

### Example 2: Wet Strength

Wet strength was determined by submerging bars into water for four days at room temperature. The strength is measured within 20 minutes after taking out the bars from the water.

The bars were made as follows. For each binder, 16 bars were manufactured from a mixture of the binder and stone wool shots from the stone wool spinning production.

A sample of this binder solution having 15% dry solid matter (16.0 g) was mixed well with shots (80.0 g). The resulting mixture was then filled into four slots in a heat resistant silicone form for making small bars (4×5 slots per form; slot top dimension: length=5.6 cm, width=2.5 cm; slot bottom dimension: length=5.3 cm, width=2.2 cm; slot height=1.1 cm). The mixtures placed in the slots were then pressed with a suitably sized flat metal bar to generate even bar surfaces. 16 bars from each binder were made in this fashion. The resulting bars were then cured typically at 225° C. The curing time was 1 h. After cooling to room temperature, the bars were carefully taken out of the containers.

The bars were broken in a 3 point bending test (test speed: 10.0 mm/min; rupture level: 50%; nominal strength: 30 N/mm2; support distance: 40 mm; max deflection 20 mm; nominal emodule10000 N/mm2) on a Bent Tram machine to investigate their mechanical strengths. The bars were placed with the “top face” up (i.e. the face with the dimensions length=5.6 cm, width=2.5 cm) in the machine.

The binder according to the invention, Binder 2, is as described above for Example 1.

### Comparative Binder 3 was Made as Follows:

A mixture of 75.1% aq. glucose syrup (19.98 g; thus efficiently 15.0 g glucose syrup), 50% aq. hypophosphorous acid (0.60 g; thus efficiently 0.30 g, 4.55 mmol hypophosphorous acid) and sulfamic acid (0.45 g, 4.63 mmol) in water (30.0 g) was stirred at room temperature until a clear solution was obtained.

28% aq. ammonia (0.80 g; thus efficiently 0.22 g, 13.15 mmol ammonia) was then added dropwise until pH=7.9. The binder solids was then measured (21.2%).

The binder mixture was diluted with water (0.403 g/g binder mixture) and 10% aq. silane (0.011 g/g binder mixture, Momentive VS-142). The final binder mixture for mechanical strength studies had pH=7.9.

Comparative Binder 1, the PUF binder, was made as described above for Example 1.

The results are shown in Table 2. As can be seen from Table 2, the wet strength of the binder according to the invention (Binder 2) was slightly lower than that of PUF, but higher than that of a comparative formaldehyde-free binder.

TABLE 2

| | | Comparative Binder 3 | Comparative |
|---|---|---|---|
| | | (sugar-based | Binder 1 |
| Binder | Binder 2 | formaldehyde free) | (PUF) |
| wet strength | 0.18 ± 0.04 | 0.15 ± 0.02 | 0.23 ± 0.08 |

### Example 3: Delamination Strength after Aging

The delamination strength after aging was measured in accordance with EN1607:2013. Aging of the MMVF test specimens was achieved exposing them to heat-moisture action for 7 days at 70±2° C. and 95±5% relative humidity in climatic chamber.

Three different binders were tested.

Comparative Binder 1 is as described above for Example 1. It is a PUF binder.

Comparative Binder 3 is as described above. It is a sugar-based binder.

Binder 2 is according to the invention, as described above.

The results are shown below in Table 3. As can be seen from Table 3, the delamination strength in percentage after 28 days for the product with the binder of the invention (Binder 2) is improved in comparison to another formaldehyde-free binder (Comparative Binder 3) and similar to that of Comparative Binder 1 (PUF).

TABLE 3
delamination in % of initial

| | 0 | 7 | 14 | 28 |
|---|---|---|---|---|
| Comparative | 100 | 67.1 | 64.7 | 62.0 |
| Binder 1 (PUF) | | | | |
| Comparative | 100 | 54.2 | 55.0 | 45.8 |
| Binder 3 | | | | |
| Binder 2 | 100 | 70.8 | 66.7 | 57.7 |

### Example 4

### Mechanical Strength Studies

### Bar Tests

The mechanical strength of the binders was tested in a bar test. For each binder, 16 bars were manufactured from a mixture of the binder and stone wool shots from the stone wool spinning production.

A sample of this binder solution having 15% dry solid matter (16.0 g) was mixed well with shots (80.0 g). The resulting mixture was then filled into four slots in a heat resistant silicone form for making small bars (4×5 slots per form; slot top dimension: length=5.6 cm, width=2.5 cm; slot bottom dimension: length=5.3 cm, width=2.2 cm; slot height=1.1 cm). The mixtures placed in the slots were then pressed with a suitably sized flat metal bar to generate even bar surfaces. 16 bars from each binder were made in this fashion. The resulting bars were then cured typically at 225° C. The curing time was 1 h. After cooling to room temperature, the bars were carefully taken out of the containers. Five of the bars were aged in a water bath at 80° C. for 3 h. This method of curing the prepared bars was used for example in Tables 1.1, 1.2, 1.4, 1.5, 1.6. Results in Table 1.3 are based on a slightly different method which includes a preconditioning step of 2 h at 90° C., followed by curing for 1 h at 225° C. while the remaining of the procedure is the same.

After drying for 3 days, the aged bars as well as five unaged bars were broken in a 3 point bending test (test speed: 10.0 mm/min; rupture level: 50%; nominal strength: 30 N/mm2; support distance: 40 mm; max deflection 20 mm; nominal e-module 10000 N/mm2) on a Bent Tram machine to investigate their mechanical strengths. The bars were placed with the “top face” up (i.e. the face with the dimensions length=5.6 cm, width=2.5 cm) in the machine.

Binder Example, Reference Binder (Phenol-Formaldehyde Resin Modified with Urea, a PUF-Resol)

This binder is a phenol-formaldehyde resin modified with urea, a PUF-resol.

A phenol-formaldehyde resin is prepared by reacting 37% aq. formaldehyde (606 g) and phenol (189 g) in the presence of 46% aq. potassium hydroxide (25.5 g) at a reaction temperature of 84° C. preceded by a heating rate of approximately 1° C. per minute. The reaction is continued at 84° C. until the acid tolerance of the resin is 4 and most of the phenol is converted. Urea (241 g) is then added and the mixture is cooled.

The acid tolerance (AT) expresses the number of times a given volume of a binder can be diluted with acid without the mixture becoming cloudy (the binder precipitates). Sulfuric acid is used to determine the stop criterion in a binder production and an acid tolerance lower than 4 indicates the end of the binder reaction.

To measure the AT, a titrant is produced from diluting 2.5 ml conc. sulfuric acid (>99%) with 1 L ion exchanged water. 5 mL of the binder to be investigated is then titrated at room temperature with this titrant while keeping the binder in motion by manually shaking it; if preferred, use a magnetic stirrer and a magnetic stick. Titration is continued until a slight cloud appears in the binder, which does not disappear when the binder is shaken.

The acid tolerance (AT) is calculated by dividing the amount of acid used for the titration (mL) with the amount of sample (mL):

AT=(Used titration volume(mL))/(Sample volume(mL))

Using the urea-modified phenol-formaldehyde resin obtained, a binder is made by addition of 25% aq. ammonia (90 mL) and ammonium sulfate (13.2 g) followed by water (1.30 kg).

The binder solids were then measured as described above and the mixture was diluted with the required amount of water and silane for mechanical measurements (15% binder solids solution, 0.5% silane of binder solids).

Binder example, reference binder (binder based on alkali oxidized lignin) 3267 kg of water is charged in 6000 l reactor followed by 287 kg of ammonia water (24.7%). Then 1531 kg of Lignin UPM BioPiva 100 is slowly added over a period of 30 min to 45 min. The mixture is heated to 40° C. and kept at that temperature for 1 hour. After 1 hour a check is made on insolubilized lignin. This can be made by checking the solution on a glass plate or a Hegman gauge. Insolubilized lignin is seen as small particles in the brown binder. During the dissolution step will the lignin solution change color from brown to shiny black. After the lignin is completely dissolved, 1 liter of a foam dampening agent (Skumdæmper 11-10 from NCÅ-Verodan) is added. Temperature of the batch is maintained at 40° C. Then addition of 307.5 kg 35% hydrogen peroxide is started. The hydrogen peroxide is dosed at a rate of 200-300 I/h. First half of the hydrogen peroxide is added at a rate of 200 l/h where after the dosage rate is increased to 300 l/h.

During the addition of hydrogen peroxide is the temperature in the reaction mixture controlled by heating or cooling in such a way that a final reaction temperature of 65° C. is reached.

The final product was analysed for the COOH group content, dry solid matter, pH, viscosity and remaining H₂O₂·60 g of this oxidized lignin (18.2% solids) was mixed with 1.4 g Primid XL552 (100% solids) and 2.8 g PEG200 (100% solids). 0.6 g Silane (Momentive VS-142 40% activity, 10% in water) and 17.4 g water were added and mixed to yield 15% solids and then used for test of mechanical properties in bar tests.

### Binder Compositions According to the Present Invention

In the following, the entry numbers of the binder example correspond to the entry numbers used in Table 1-1 to 1-6.

The carboxylic acid group content of all lignosulfonates used for the binders according to the present invention was measured using ³¹P NMR and was found to be in the range of 0.05 to 0.6 mmol/g, based on the dry weight of the lignosulfonate lignins, for all examples.

### Example 2

To 30.0 g lignosulfonate solution (50% solids), 0.4 g NH₄OH (24.7%) was added and mixed followed by addition of 1.9 g Primid XL552 (100% solids) and mixing. Finally, 0.7 g Silane (Momentive VS-142 40% activity, 10% in water) and 64.3 g water were added and mixed to yield 15% solids and then used for test of mechanical properties in bar tests.

### Example 11

To 30.0 g lignosulfonate solution (50% solids), 0.4 g NH₄OH (24.7%) was added and mixed followed by addition of 2.1 g Primid XL552 (100% solids) and 3.4 g PEG 200 (100% solids) and mixing. Finally, 0.7 g Silane (Momentive VS-142 40% activity, 10% in water) and 61.8 g water were added and mixed to yield 15% solids and then used for test of mechanical properties in bar tests.

### Example 15

To 30.0 g lignosulfonate solution (50% solids), 0.4 g NH₄OH (24.7%) was added and mixed followed by addition of 2.9 g Primid XL552 (100% solids) and 3.4 g PEG 200 (100% solids) and mixing. Finally, 0.8 g Silane (Momentive VS-142 40% activity, 10% in water) and 67 g water were added and mixed to yield 15% solids and then used for test of mechanical properties in bar tests.

### Example 30

To 30.0 g lignosulfonate solution (50% solids), 0.4 g NH₄OH (24.7%) was added and mixed followed by addition of 2.9 g Primid XL552 (100% solids) and 3.4 g 1,1,1 tris(hydroxymethyl)propane (100% solids) and mixing. Finally, 0.8 g Silane (Momentive VS-142 40% activity, 10% in water) and 67 g water were added and mixed to yield 15% solids and then used for test of mechanical properties in bar tests.

### Example 33

To 100.0 g lignosulfonate solution (50% solids), 0.3 g KOH in pellet form was added and mixed followed by addition of 10.8 g Primid XL552 (100% solids) and 11.3 g PEG 200 (100% solids) and mixing. Finally, 2.6 g Silane (Momentive VS-142 40% activity, 10% in water) and 228 g water were added and mixed to yield 15% solids and then used for test of mechanical properties in bar tests.

### Example 41

To 30.0 g lignosulfonate solution (50% solids), 0.4 g NH₄OH (24.7%) was added and mixed followed by addition of 1.9 g Primid XL552 (100% solids) and 1.7 g PEG 200 (100% solids) and 1.7 g urea (100% solids) and mixing. Finally, 0.7 g Silane (Momentive VS-142 40% activity, 10% in water) and 60.5 g water were added and mixed to yield 15% solids and then used for test of mechanical properties in bar tests.

Mechanical properties are presented in Tables 1.1-1.6. Further example binder compositions were prepared, as shown in Tables 1.1 to 1.6. For simplicity, quantities of all other components are recalculated based on 100 g of dry lignin.

As can be seen from Table 1.1 a combination of crosslinker (Primid XL 552) and plasticizer (PEG 200) is required to achieve high mechanical properties (unaged and aged strength in bar test) that are at comparable level to reference binder (11 and 15 versus 2 and 9 versus reference binder).

Table 1.2 and 1.3 show that different plasticizers can be used (13 and 15 versus 30) or combination of plasticizers (34 versus 41) and that the PEG 200 is a preferred plasticizer.

Table 1.4 shows that addition of silane can help achieve aged strength on the same level as reference binders.

Table 1.5 shows that the binder has high strength without the presence of a base but that a non-permanent base (NH₄OH) or a permanent base (KOH) can be added to the formulation to protect the production equipment from corrosion without significant changes in strength.

Table 1.6 shows that different lignosulfonates can be used.

This overall means, we are able to produce a MMVF product based on a phenol-free and formaldehyde-free binder composition with a high content of renewable material based on lignin, which has comparable mechanical properties to the reference systems and can be produced in a simpler and less expensive way.

TABLE 1.1

| | Reference binder | Reference binder | | | | | | | |
|---|---|---|---|---|---|---|---|---|---|
| | (Phenol-formaldehyde | (binder based | | | | | | | |
| | resin modified with | on alkali | | | | | | | |
| | urea, a PUF-resol) | oxidized lignin) | 1 | 2 | 8 | 9 | 10 | 11 | 15 |
| Binder composition | | | | | | | | | |
| ammonium lignosulfonate (g dry lignin) | | | 100 | 100 | 100 | 100 | 100 | 100 | 100 |
| ammonium calcium lignosulfonate | | | | | | | | | |
| (g dry lignin) | | | | | | | | | |
| PEG 200 (g) | | | 0 | 0 | 23 | 40 | 23 | 23 | 23 |
| 1,1,1 tris(hydroxymethyl)propane (g) | | | | | | | | | |
| urea (g) | | | | | | | | | |
| NH4OH (g) | | | 0.8 | 0.8 | 0.8 | 0.8 | 0.8 | 0.8 | 0.8 |
| KOH (g) | | | | | | | | | |
| Primid XL552 (g) | | | 0 | 14 | 10 | 0 | 7 | 14 | 20 |
| Momentive VS 142 (% of binder solids), | | | 0.5 | 0.5 | 0.5 | 0.5 | 0.5 | 0.5 | 0.5 |
| based on 40% activity | | | | | | | | | |
| Binder properties | | | | | | | | | |
| Mechanical strength, unaged (N), bars | 350 | 270 | 60 | 280 | 70 | 150 | 110 | 230 | 320 |
| tests | | | | | | | | | |
| Mechanical strength, aged (N), bar | 150 | 130 | 0 | 50 | 20 | 40 | 50 | 140 | 130 |
| tests | | | | | | | | | |
| Curing temp, ° C. | 200 | 225 | 225 | 225 | 225 | 225 | 225 | 225 | 225 |

TABLE 1.2

| | 12 | 13 | 15 | 26 | 27 | 28 | 29 | 30 |
|---|---|---|---|---|---|---|---|---|
| Binder composition | | | | | | | | |
| ammonium lignosulfonate (g dry lignin) | 100 | 100 | 100 | 100 | 100 | 100 | 100 | 100 |
| ammonium calcium lignosulfonate (g dry lignin) | | | | | | | | |
| PEG 200 (g) | 23 | 23 | 23 | | | | | |
| 1,1,1 tris(hydroxymethyl)propane (g) | | | | 23 | 23 | 40 | 23 | 23 |
| urea (g) | | | | | | | | |
| Primid XL552 (g) | 13 | 13 | 20 | 0 | 0 | 0 | 20 | 20 |
| NH4OH (g) | 0.8 | 0.8 | 0.8 | 0.8 | 0.8 | 0.8 | 0.8 | 0.8 |
| KOH (g) | | | | | | | | |
| Momentive VS 142 (% of binder solids), based on 40% activity | 0 | 0.5 | 0.5 | 0 | 0.5 | 0.5 | 0 | 0.5 |
| Binder properties | | | | | | | | |
| Mechanical strength, unaged (N), bars tests | 250 | 250 | 320 | 80 | 90 | 90 | 200 | 210 |
| Mechanical strength, aged (N), bar tests | 30 | 110 | 130 | 10 | 10 | 20 | 60 | 100 |
| Curing temp, ° C. | 225 | 225 | 225 | 225 | 225 | 225 | 225 | 225 |

TABLE 1.3

| | 34 | 36 | 39 | 40 | 41 |
|---|---|---|---|---|---|
| Binder composition | | | | | |
| ammonium lignosulfonate (g dry | 100 | 100 | 100 | 100 | 100 |
| lignin) | | | | | |
| ammonium calcium lignosulfonate | | | | | |
| (g dry lignin) | | | | | |
| PEG 200 (g) | 23 | 12 | 4.5 | 0 | 12 |
| 1,1,1 tris(hydroxymethyl)propane | | | | | |
| (g) | | | | | |
| urea (g) | | | | | 12 |
| Primid XL552 (g) | 13 | 13 | 13 | 13 | 13 |
| NH4OH (g) | 0.8 | 0.8 | 0.8 | 0.8 | 0.8 |
| KOH (g) | | | | | |
| Momentive VS 142 (% of binder | 0.5 | 0.5 | 0.5 | 0.5 | 0.5 |
| solids), based on 40% activity | | | | | |
| Binder properties | | | | | |
| Mechanical strength, unaged (N), | 150 | 150 | 140 | 60 | 135 |
| bars tests | | | | | |
| Mechanical strength, aged (N), | 60 | 50 | 40 | 20 | 40 |
| bar tests | | | | | |
| Curing temp, ° C. | 225 | 225 | 225 | 225 | 225 |

TABLE 1.4

| | 12 | 13 | 14 | 15 | 29 | 30 |
|---|---|---|---|---|---|---|
| Binder composition | | | | | | |
| ammonium lignosulfonate (g dry lignin) | 100 | 100 | 100 | 100 | 100 | 100 |
| ammonium calcium lignosulfonate (g dry lignin) | | | | | | |
| PEG 200 (g) | 23 | 23 | 23 | 23 | | |
| 1,1,1 tris(hydroxymethyl)propane (g) | | | | | 23 | 23 |
| urea (g) | | | | | | |
| Primid XL552 (g) | 13 | 13 | 20 | 20 | 20 | 20 |
| NH4OH (g) | 0.8 | 0.8 | 0.8 | 0.8 | 0.8 | 0.8 |
| KOH (g) | | | | | | |
| Momentive VS 142 (% of binder solids), based on 40% activity | 0 | 0.5 | 0 | 0.5 | 0 | 0.5 |
| Binder properties | | | | | | |
| Mechanical strength, unaged (N), bars tests | 250 | 250 | 380 | 320 | 200 | 210 |
| Mechanical strength, aged (N), bar tests | 30 | 110 | 40 | 130 | 60 | 100 |
| Curing temp, ° C. | 225 | 225 | 225 | 225 | 225 | 225 |

TABLE 1.5

| | 31 | 32 | 33 |
|---|---|---|---|
| Binder composition | | | |
| ammonium lignosulfonate (g dry | 100 | 100 | 100 |
| lignin) | | | |
| ammonium calcium lignosulfonate | | | |
| (g dry lignin) | | | |
| PEG 200 (g) | 23 | 23 | 23 |
| 1,1,1 tris(hydroxymethyl)propane | | | |
| (g) | | | |
| urea (g) | | | |
| Primid XL552 (g) | 22 | 22 | 22 |
| NH4OH (g) | 0 | 1.0 | 0 |
| KOH (g) | 0 | 0 | 0.6 |
| Momentive VS 142 (% of binder | 0.5 | 0.5 | 0.5 |
| solids), based on 40% activity | | | |
| Binder properties | | | |
| Mechanical strength, unaged (N), | 330 | 300 | 290 |
| bars tests | | | |
| Mechanical strength, aged (N), | 160 | 120 | 130 |
| bar tests | | | |
| Curing temp, ° C. | 225 | 225 | 225 |

TABLE 1.6

| | 11 | 15 | 45 | 46 |
|---|---|---|---|---|
| Binder composition | | | | |
| ammonium lignosulfonate (g dry | 100 | 100 | | |
| lignin) | | | | |
| ammonium calcium lignosulfonate | | | 100 | 100 |
| (g dry lignin) | | | | |
| PEG 200 (g) | 23 | 23 | 23 | 23 |
| 1,1,1 tris(hydroxymethyl)propane | | | | |
| (g) | | | | |
| urea (g) | | | | |
| Primid XL552 (g) | 13 | 20 | 13 | 20 |
| NH4OH (g) | 0.8 | 0.8 | 0.8 | 0.8 |
| KOH (g) | | | | |
| Momentive VS 142 (% of binder | 0.5 | 0.5 | 0.5 | 0.5 |
| solids), based on 40% activity | | | | |
| Binder properties | | | | |
| Mechanical strength, unaged (N), | 230 | 320 | 210 | 300 |
| bar tests | | | | |
| Mechanical strength, aged (N), | 140 | 130 | 120 | 130 |
| bar tests | | | | |
| Curing temp, ° C. | 225 | 225 | 225 | 225 |

### Examples 47-54

In the following, the entry numbers of the binder example correspond to the entry numbers used in Table 2.1.

The carboxylic acid group content of all lignosulfonates used for the binders according to the present invention was measured using ³¹P NMR and was found to be in the range of 0.05 to 0.6 mmol/g, based on the dry weight of the lignosulfonate lignins, while it was found for this specific batch used for examples 47, 48, 49, 50, 51, 52, 53, 54 to be 0.14 mmol/g.

### Example 47

To 30.0 g lignosulfonate solution (50% solids), 0.4 g NH₄OH (24.7%) was added and mixed followed by addition of 0.7 g Silane (Momentive VS-142 40% activity, 10% in water) and 68.9 g water were added and mixed to yield 15% solids and then used for test of mechanical properties in bar tests.

### Example 49

To 30.0 g lignosulfonate solution (50% solids), 0.4 g NH₄OH (24.7%) was added and mixed followed by addition of 6.0 g Primid XL552 (100% solids) and mixing. Finally, 1.0 g Silane (Momentive VS-142 40% activity, 10% in water) and 102.6 g water were added and mixed to yield 15% solids and then used for test of mechanical properties in bar tests.

Mechanical properties are presented in Table 2.1. Further example binder compositions were prepared, as shown in Table 2.1. For simplicity, quantities of all other components are recalculated based on 100 g of dry lignin.

As can be seen from Table 2.1, in a combination of lignosulfonate and crosslinker (Primid XL 552) higher amounts of crosslinker lead to better mechanical properties.

TABLE 2.1

| | PUF ref | 47 | 48 | 49 | 50 |
|---|---|---|---|---|---|
| Binder composition | | | | | |
| ammonium lignosulfonate | | 100 | 100 | 100 | 100 |
| (g solids) | | | | | |
| PEG 200 (g) | | 0 | 0 | 0 | 0 |
| urea (g) | | | | | |
| ammonia, 24.7% (g) | | 2.5 | 2.5 | 2.5 | 2.5 |
| Primid XL552 (g) | | 0 | 25 | 40 | 60 |
| Momentive VS 142 (% of | | 0.5 | 0.5 | 0.5 | 0.5 |
| binder solids), based on | | | | | |
| 40% activity | | | | | |
| Binder properties | | | | | |
| Mechanical strength, unaged | 350 | 60 | 280 | 460 | 640 |
| (N), bars tests | | | | | |
| Mechanical strength, aged | 150 | 0 | 160 | 180 | 230 |
| (N), bar tests | | | | | |
| Curing temp, ° C. | 200 | 225 | 225 | 225 | 225 |

### Example 53: Test of Stone Wool Products

The low density products have been examined for properties according to the product standard for Factory made mineral wool (MW) products, DS/EN13162:2012+A1:2015, meaning relevant mechanical properties besides other basic characteristics for stone wool products.

The testing has been performed on slabs, where test specimens according to the dimensional specifications and to the number of test specimens required to get one test result, as stated in EN13162 for each of the different test methods, has been cut out. Each of the stated values for the mechanical properties obtained is an average of more results according to EN13162.

Tests are performed on products or test specimens sampled directly from the production line before packing (line cuts) and/or for products or test specimens sampled from packs 24 hours after packing (24 h packs).

### Dimensions

Dimensions of products and test specimens has been performed according to the relevant test methods, DS/EN822:2013: Thermal insulating products for building applications—Determination of length and width, and DS/EN823:2013: Thermal insulating products for building applications—Determination of thickness.

### Binder Content (Loss on Ignition)

Determination of binder content is performed according to DS/EN13820:2003: Thermal insulating materials for building applications-Determination of organic content, where the binder content is defined as the quantity of organic material burnt away at a given temperature, stated in the standard to be (500±20° C.). In the testing the temperature (590±20° C., for at least 10 min or more until constant mass) has been used in order to make sure that all organic material is burnt away. Determination of ignition loss consists of at least 10 g wool corresponding to 8-20 cut-outs (minimum 8 cut-outs) performed evenly distributed over the test specimen using a cork borer ensuring to comprise an entire product thickness. The binder content is taken as the LOI. The binder includes binder additives.

### Tensile Strength

The tensile strength of low density products has been determined according to EN 1608:2013: Thermal insulating products for building applications-Determination of tensile strength parallel to faces. The tensile strength is measured on test specimens from line cuts and on test specimens from 24 h packs.

Self Deflection (f70)

Self-deflection is measured according to an internal test method for determining the deflection caused by the net weight of a product. A test-specimen of length: 990±10 mm and width: min. 270±5 mm and max 680±5 mm is placed horizontally on two supports (tilting table) with a mutual centre distance of (700±2) mm and two moveable supporting devices. The self-deflection is measured in the middle of the specimen and recorded either mechanically or electrically (transducer with display) and read either on a scale or a digital display. If the original product is longer than 990±10 mm the extra length is cut off. The self-deflection is measured on both surfaces of the test specimen. The accuracy of measurement is ±0.2 mm for self-deflection<10 mm and ±1 mm for self-deflection>10 mm).

The self-deflection is reported as (f70, 70 cm span)=(f1+f2)/2 mm, where f1 is the measurement with surface 1 facing up and f2 is the measurement with surface 2 facing up.

Testing is performed on test specimens from line cuts and on test specimens from 24 h packs.

### Example 53

The stone wool product has been produced by use of binder in example 53, at a curing oven temperature set to 275° C.

609.0 kg of ammonium lignosulfonate was placed in a mixing vessel to which 8 l NH₄OH (24,7%) was added and stirred. Afterwards, 384 kg Primid XL552 solution (pre-made 31 wt % solution in water) was added and mixed followed by addition of 14 kg Silane (Momentive VS-142 40% activity, 10% in water).

The binder from this example is used to produce a low density stone wool product, thickness and density were measured as indicated in Table 3.1. Curing oven temperature was set to 275° C.

### Example 54

The stone wool product has been produced by use of binder in example 54, at a curing oven temperature set to 255° C. 730.0 kg of ammonium lignosulfonate was placed in a mixing vessel to which 8.5 l NH₄OH (24,7%) was added and stirred. Afterwards, 151 kg Primid XL552 solution (pre-made 31 wt % solution in water) and 43 kg PEG 200 (100% solids) were added and mixed followed by addition of 13 kg Silane (Momentive VS-142 40% activity, 10% in water).

The binder from this example is used to produce a high density stone wool product, 100 mm thickness, 145 kg/m³ density, wherein the product has a loss on ignition (LOI) of 3.5 wt %. Curing oven temperature was set to 255° C.

TABLE 3.1

| | Tensile strength, crosswise - packs | | | | Tensile strength, crosswise - line cuts | | | | |
|---|---|---|---|---|---|---|---|---|---|
| | | Ignition | Self deflection | Sample | Sigma | Ignition | | Sample | Sigma |
| | Thickness | loss | f(70) | density | (t) | loss | Thickness | density | (t) |
| Example | mm | % | mm | kg/m3 | kPa | % | mm | kg/m3 | kPa |
| PUF-reference | 145 | 2.82 | 7.2 | 32.3 | 7.6 | 2.50 | 153 | 31.0 | 10.2 |
| 53 | 139 | 2.81 | 8.9 | 34.3 | 6.7 | 2,.54 | 158 | 30.7 | 8.7 |

1. A method of draining water comprising the steps of:
providing a water drainage device, wherein the water drainage device comprises man-made vitreous fibres (MMVF) bonded with a cured aqueous binder composition free of phenol and formaldehyde;
positioning the water drainage device in contact with the ground, wherein the water drainage device absorbs water and releases water to a recipient;
wherein the aqueous binder composition prior to curing comprises;
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

2. The method according to claim 1, wherein the aqueous binder composition further comprising a component (iii) in form of one or more plasticizers.

3. The method according to claim 1, with the proviso that the aqueous binder composition does not comprise a cross-linker selected from:
epoxy compounds having a molecular weight Mw of 500 or less
carbonyl compounds selected from aldehydes, carbonyl compounds of the formula R—[C(O)R₁]ₓ
in which:
R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups, R₁ represents a hydrogen atom or a C₁-C₁₀ alkyl radical, and x varies from 1 to 10,
polyamines.

4. The method according to claim 1, wherein component (i) is having a carboxylic acid group content of 0.05 to 0.6 mmol/g, based on the dry weight of lignosulfonate lignins.

5. The method according to claim 1, wherein component (i) is in form of one or more lignosulfonate lignins having an average carboxylic acid group content of less than 1.8 groups per macromolecule considering the M_n wt. average of component (i), such as less than 1.4 such as less than 1.1 such as less than 0.7 such as less than 0.4.

6. The method according to claim 1, wherein component (i) is having a content of phenolic OH groups of 0.3 to 2.5 mmol/g, such as 0.5 to 2.0 mmol/g, such as 0.5 to 1.5 mmol/g, based on the dry weight of lignosulfonate lignins.

7. The method according to claim 1, wherein component (i) is having a content of aliphatic OH groups of 1.0 to 8.0 mmol/g, such as 1.5 to 6.0 mmol/g, such as 2.0 to 5.0 mmol/g, based on the dry weight of lignosulfonate lignins.

8. The method according to claim 1, wherein the component (i) comprises ammoniumlignosulfonates and/or calciumlignosulfonates, and/or magnesiumlignosulfonates, and any combinations thereof.

9. The method according to claim 1, wherein component (i) comprises ammoniumlignosulfonates and calciumlignosulfonates, wherein the molar ratio of NH₄⁺ to Ca₂⁺ is in the range of 5:1 to 1:5, in particular 3:1 to 1:3.

10. The method according to claim 1, wherein the aqueous binder composition contains added sugar in an amount of 0 to less than 5 wt.-%, based on the weight of lignosulfonate and sugar.

11. The method according to claim 1, wherein the aqueous binder composition comprises component (i) in an amount of 50 to 98 wt.-%, such as 65 to 98 wt.-%, such as 80 to 98 wt.-%, based on the dry weight of components (i) and (ii).

12. The method according to claim 1, wherein the component (ii) is in form of one or more cross-linkers selected from:
β-hydroxyalkylamide-cross-linkers, and/or
oxazoline-cross-linkers, and/or
the group consisting of multifunctional organic amines such as an alkanolamine, diamines, such as hexamethyldiamine, and/or
epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, and/or
one or more cross-linkers selected from the group consisting of fatty amines; and/or
one more cross-linkers in form of fatty amides; and/or
one or more cross-linkers selected from polyester polyols, such as polycaprolactone; and/or
one or more cross-linkers selected from the group consisting of starch, modified starch, CMC; and/or
one or more cross-linkers in form of multifunctional carbodiimides, such as aliphatic multifunctional carbodiimides; and/or
one or more cross-linkers selected from melamine based cross-linkers, such as a hexakis(methylmethoxy)melamine (HMMM) based cross-linkers.

13. The method according to claim 1, wherein the component (ii) comprises one or more cross-linkers selected from β-hydroxyalkylamide-cross-linkers and/or oxazoline-cross-linkers.

14. The method according to claim 1, wherein the binder composition comprises component (ii) in an amount of 1 to 50 wt.-%, such as 4 to 20 wt.-%, such as 6 to 12 wt.-%, based on the dry weight of component (i).

15. The method according to claim 1, wherein the component (ii) is in form of one or more cross-linkers selected from:
β-hydroxyalkylamide-cross-linkers, such as N-(2-hydroxyisopropyl)amide-cross-linkers, such as N-(2-hydroxyethyl)amide-cross-linkers, such as N-(2-hydroxyethyl)adipamide-cross-linkers, such as N,N,N′,N′-tetrakis(2-hydroxyethyl)adipamide and/or
the group consisting of multifunctional organic amines such as an alkanolamine, diamines, such as hexamethyldiamine, and/or
epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, and/or
one or more cross-linkers in form of multifunctional carbodiimides, such as aliphatic multifunctional carbodiimides.

16. The method according to claim 1, wherein the component (ii) comprises one or more cross-linkers selected from β-hydroxyalkylamide-cross-linkers, such as N-(2-hydroxyisopropyl)amide-cross-linkers, such as N-(2-hydroxyethyl)amide-cross-linkers, such as N-(2-hydroxyethyl)adipamide-cross-linkers, such as N,N,N′,N′-tetrakis(2-hydroxyethyl)adipamide.

17. The method according to claim 1, wherein the binder compositions comprises component (ii) in an amount of 2 to 90 wt.-%, such as 6 to 60 wt.-%, such as 10 to 40 wt.-%, such as 25 to 40 wt.-%, based on the dry weight of component (i).

18. The method according to claim 2, wherein component (iii) is in form of:
one or more plasticizers selected from the group consisting of fatty alcohols, monohydroxy alcohols, such as pentanol, stearyl alcohol; and/or
one or more plasticizers selected from the group consisting of alkoxylates such as ethoxylates, such as butanol ethoxylates, such as butoxytriglycol; and/or
one or more plasticizers in form of propylene glycols; and/or
one or more plasticizers in form of glycol esters; and/or
one or more plasticizers selected from the group consisting of adipates, acetates, benzoates, cyclobenzoates, citrates, stearates, sorbates, sebacates, azelates, butyrates, valerates; and/or
one or more plasticizers selected from the group consisting of phenol derivatives, such as alkyl or aryl substituted phenols; and/or
one or more plasticizers selected from the group consisting of silanols, siloxanes; and/or
one or more plasticizers selected from the group consisting of sulfates such as alkyl sulfates, sulfonates such as alkyl aryl sulfonates such as alkyl sulfonates, phosphates such as tripolyphosphates; and/or
one or more plasticizers in form of hydroxy acids; and/or
one or more plasticizers selected from the group consisting of monomeric amides, such as acetamides, benzamide, fatty acid amides such as tall oil amides; and/or
one or more plasticizers selected from the group consisting of quaternary ammonium compounds such as trimethylglycine, distearyldimethylammoniumchloride; and/or
one or more plasticizers selected from the group consisting of vegetable oils such as castor oil, palm oil, linseed oil, soybean oil; and/or
tall oil, and/or
one or more plasticizers selected from the group consisting of hydrogenated oils, acetylated oils; and/or
one or more plasticizers selected from acid methyl esters; and/or
one or more plasticizers selected from the group consisting of alkyl polyglucosides, gluconamides, aminoglucoseamides, sucrose esters, sorbitan esters; and/or
one or more plasticizers selected from the group consisting of polyethylene glycols, polyethylene glycol ethers; and/or
one or more plasticizers in form of polyols, such as glycerol, such as 1,1,1-Tris(hydroxymethyl)propane; and/or
triethanolamine.

19. The method according to claim 2, wherein component (iii) is in form of propylene glycols, phenol derivatives, silanols, siloxanes, hydroxy acids, vegetable oils, polyethylene glycols, polyethylene glycol ethers, triethanolamine, or any mixtures thereof.

20. The method according to claim 2, wherein component (iii) comprises one or more plasticizers having a boiling point of 100 to 380° C., more preferred 120 to 300° C., more preferred 140 to 250° C.

21. The method according to claim 2, wherein component (iii) comprises one or more polyethylene glycols having an average molecular weight of 150 to 50000 g/mol, in particular 150 to 4000 g/mol, more particular 150 to 1000 g/mol, preferably 150 to 500 g/mol, more preferably 200 to 400 g/mol.

22. The method according to claim 2, wherein the component (iii) is present in an amount of 0.5 to 60, preferably 2.5 to 25, more preferably 3 to 15 wt.-%, based on the dry weight of component (i).

23. The method according to claim 1, wherein the aqueous binder composition comprises a further component (iv) in form of one or more coupling agents, such as organofunctional silanes.

24. The method according to claim 1, wherein the aqueous binder composition comprises a component (v) in form of one or more components selected from the group of bases, such as ammonia, such as alkali metal hydroxides, such as KOH, such as earth alkaline metal hydroxides, such as Ca(OH)₂, such as Mg(OH)₂, such as amines or any salts thereof.

25. The method according to claim 1, wherein the aqueous binder composition comprises a further component in form of urea, in particular in an amount 5 to 40 wt.-%, such as 10 to 30 wt.-%, such as 15 to 25 wt.-%, based on the dry weight of component (i).

26. The method according to claim 1, wherein the water drainage device does not contain an ammonia-oxidized lignin (AOL).

27. The method according to claim 1, wherein the water drainage device comprises a first conduit having a first open end and a second open end, wherein the first open end is in fluid communication with the water drainage device, preferably wherein the first conduit conveys water into the water drainage device.

28. The method according to claim 1, wherein the water drainage device comprises a second conduit having a first open end and a second open end, wherein the first open end is in fluid communication with the water drainage device, preferably wherein the second conduit conveys air out of the water drainage device.

29. The method according to claim 1, wherein the water drainage device comprises a passage which extends from a first end of the water drainage device, towards a second end of the water drainage device, wherein the first and second ends are opposed, preferably wherein the first end of the passage is in fluid communication with water from the first conduit and/or the second conduit.

30. The method according to claim 1, wherein the water drainage device absorbs water from the ground water; from guttering and/or from draining systems of buildings or streets.

31. The method according to claim 1, wherein the recipient is selected from the following list: the ground, a reservoir, a tank, a drain pipe, a conduit, a passage, a water collection point, a gutter or a sewer.

32. The method according to claim 1, wherein the water drainage device comprises MMVF having a geometric fibre diameter of 1.5 to 10 microns, preferably 2 to 8 microns, more preferably 2 to 5 microns.

33. The method according to claim 1, wherein the water drainage device has a volume in the range of 10 litres to 300 litres, preferably 100 litres to 250 litres, more preferably 150 litres to 200 litres

34. The method according to claim 1, wherein the water drainage device does not comprise any wetting agent.

35. The method according to claim 1, wherein the water drainage device has a contact angle with water of less than 90° and/or a hydraulic conductivity of 5 m/day to 300 m/day, preferably 50 m/day to 200 m/day.

36. A water drainage device comprising man-made vitreous fibres (MMVF) bonded with a cured aqueous binder composition free of phenol and formaldehyde, wherein the aqueous binder composition prior to curing comprises;
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

37. The water drainage device according to claim 36, wherein the aqueous binder composition prior to curing further comprises a component (iii) in form of one or more plasticizer.

38. An array of two or more water drainage devices, wherein the water drainage devices comprise man-made vitreous fibres (MMVF) bonded with a cured aqueous binder composition free of phenol and formaldehyde, wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

39. The array according to claim 38, wherein the aqueous binder composition prior to curing further comprises a component (ii) in form of one or more plasticizers.

40. A method of producing a water drainage device comprising the steps of:
(i) providing man-made vitreous fibres;
(ii) spraying the man-made vitreous fibres with an aqueous binder composition free of phenol and formaldehyde;
(iii) collecting and consolidating the man-made vitreous fibres and curing the aqueous binder composition to form a water drainage device;
wherein the binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

41. Use of a lignin component in form of one or more lignosulfonate lignins having a carboxylic acid group content of 0.03 to 1.4 mmol/g, based on the dry weight of the lignosulfonate lignins, for the preparation of a binder composition free of phenol and formaldehyde for a water drainage device comprising man-made vitreous fibres (MMVF).
